(19) United States
(12) Patent Application Publication
(10) Pub. No.: US 2025/0008357 A1
(43) Pub. Date: Jan. 2, 2025

(54) BEAM MEASUREMENT AND REPORTING

(71) Applicant: Samsung Electronics Co., Ltd., Suwon-si (KR)

(72) Inventors: Dalin Zhu, Allen, TX (US); Eko Onggosanusi, Coppell, TX (US)

(21) Appl. No.: 18/744,342

(22) Filed: Jun. 14, 2024

Related U.S. Application Data
(60) Provisional application No. 63/524,538, filed on Jun. 30, 2023.

(51) Int. Cl. H04W 24/08

(52) U.S. Cl. CPC H04W 24/08

(57) ABSTRACT

Methods and apparatuses for beam measurement and reporting. A method performed by a user equipment (UE) includes transmitting capability information; receiving information indicating a group based beam reporting; and measuring reference signals. The method further includes determining, based on the information and the measurement, a group of two resource indicators; determining, based on the measurement, beam metrics corresponding to the group of two resource indicators; and transmitting, in a channel state information (CSI) reporting instance, the group of two resource indicators and the beam metrics. A resource indicator in the group of two resource indicators is one of: (1) a synchronization signal/physical broadcast channel (PBCH) block (SSB) resource indicator (SSBRI) and (2) a CSI reference signal (CSI-RS) resource indicator (CRI). A beam metric in the beam metrics is one of: (1) a layer-1 reference signal received power (L1-RSRP) and (2) a layer-1 signal to interference and noise ratio (L1-SINR).

### CROSS-REFERENCE TO RELATED AND CLAIM OF PRIORITY

The present application claims priority under 35 U.S.C. § 119 (e) to U.S. Provisional Patent Application No. 63/524,538 filed on Jun. 30, 2023, which is hereby incorporated by reference in its entirety.

### TECHNICAL FIELD

The present disclosure relates generally to wireless communication systems and, more specifically, the present disclosure relates to methods and apparatuses for beam measurement and reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to beam measurement and reporting.

In one embodiment, a user equipment (UE) is provided. The UE includes a transceiver configured to transmit capability information and receive information indicating a group based beam reporting. The UE further includes a processor operably coupled with the transceiver. The processor is further configured to measure reference signals, determine, based on the information and the measurement, a group of two resource indicators, and determine, based on the measurement, beam metrics corresponding to the group of two resource indicators. The transceiver is further configured to transmit, in a channel state information (CSI) reporting instance, the group of two resource indicators and the beam metrics. A resource indicator in the group of two resource indicators is one of: (1) a synchronization signal/physical broadcast channel (PBCH) block (SSB) resource indicator (SSBRI) and (2) a CSI reference signal (CSI-RS) resource indicator (CRI). A beam metric in the beam metrics is one of: (1) a layer-1 reference signal received power (L1-RSRP) and (2) a layer-1 signal to interference and noise ratio (L1-SINR).

In another embodiment, a base station (BS) is provided. The BS includes a processor and a transceiver operably coupled with the processor. The transceiver is configured to receive capability information; transmit information indicating a group based beam reporting; and receive, in a CSI reporting instance, a group of two resource indicators and beam metrics corresponding to the group of two resource indicators. A resource indicator in the group of two resource indicators is one of a SSBRI and a CRI. A beam metric in the beam metrics is one of a L1-RSRP and a L1-SINR.

In yet another embodiment, a method performed by a UE is provided. The method includes transmitting capability information; receiving information indicating a group based beam reporting; measuring reference signals; determining, based on the information and the measurement, a group of two resource indicators; determining, based on the measurement, beam metrics corresponding to the group of two resource indicators; and transmitting, in a CSI reporting instance, the group of two resource indicators and the beam metrics. A resource indicator in the group of two resource indicators is one of a SSBRI and a CRI. A beam metric in the beam metrics is one of a L1-RSRP and a L1-SINR.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example multiple transmission-and-reception-point (multi-TRP) system according to embodiments of the present disclosure;

FIG. 8 illustrates a diagram of example resource indicator/beam reporting groups for simultaneous reception/transmission according to embodiments of the present disclosure; and

FIG. 9 illustrates an example method performed by a UE in a wireless communication system according to embodiments of the present disclosure.

### DETAILED DESCRIPTION

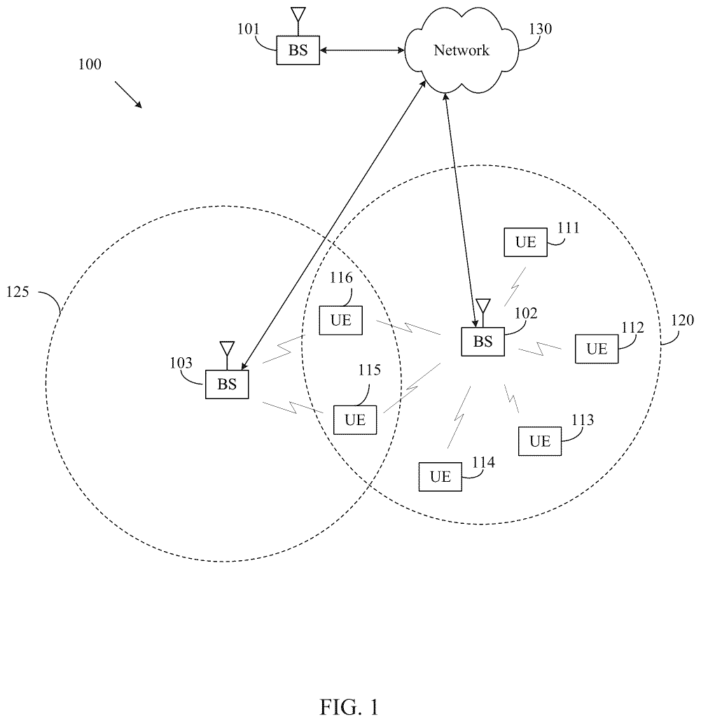

FIGS. 1-9, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mm Wave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v16.1.0, “NR; Physical channels and modulation;” [2] 3GPP TS 38.212 v16.1.0, “NR; Multiplexing and Channel coding;” [3] 3GPP TS 38.213 v16.1.0, “NR; Physical Layer Procedures for Control;” [4] 3GPP TS 38.214 v16.1.0, “NR; Physical Layer Procedures for Data;” [5] 3GPP TS 38.321 v16.1.0, “NR; Medium Access Control (MAC) protocol specification;” and [6] 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for to perform beam measurement and reporting. In certain embodiments, one or more of the BSs 101-103 include circuitry, programing, or a combination thereof to support beam measurement and reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

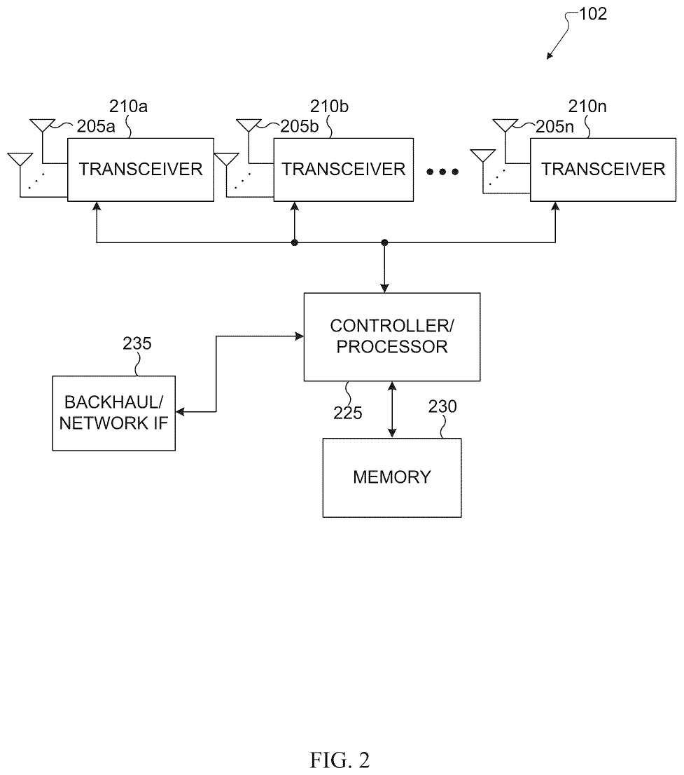

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting beam measurement and reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

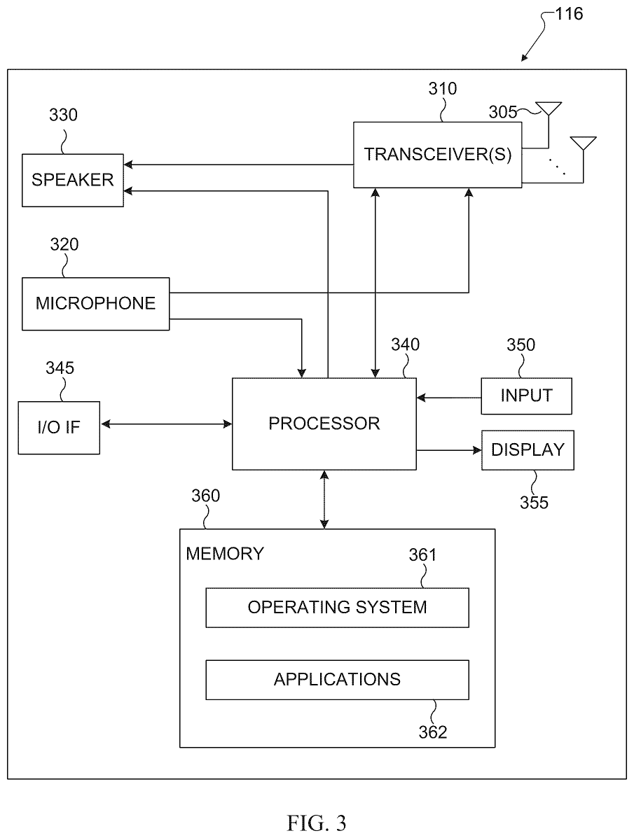

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to perform beam measurement and reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

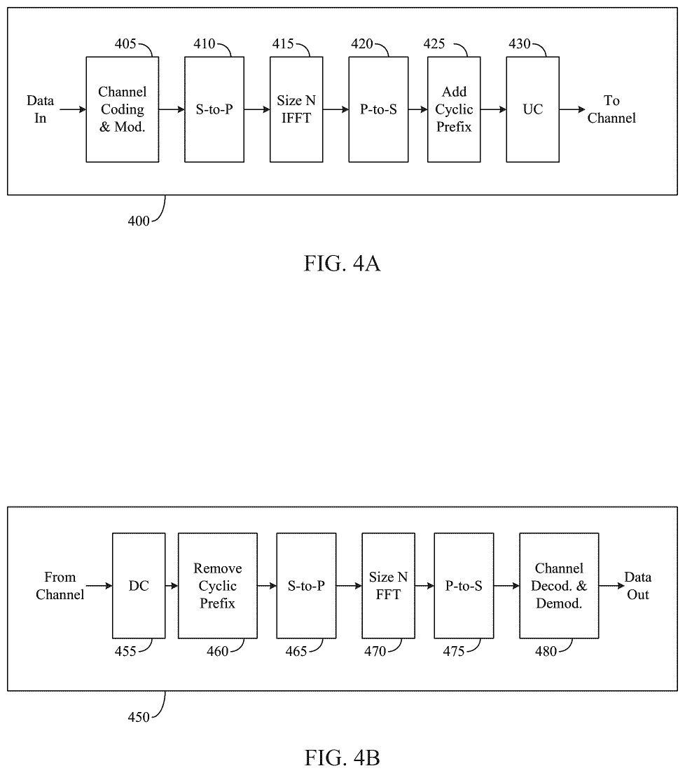

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to support beam measurement and reporting as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

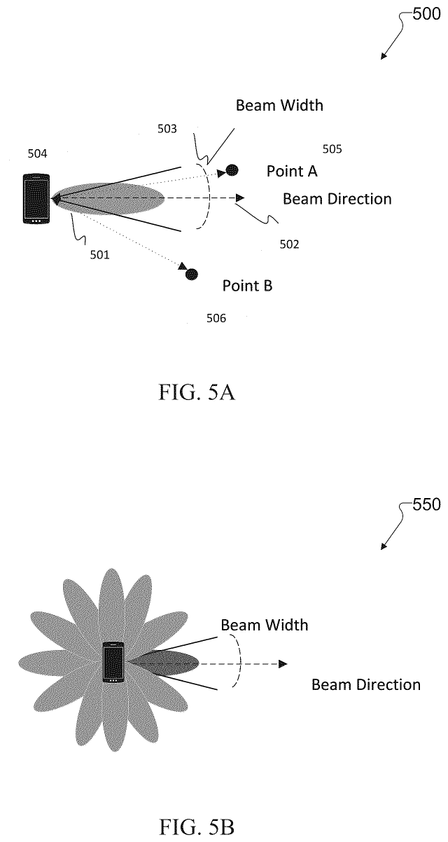

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

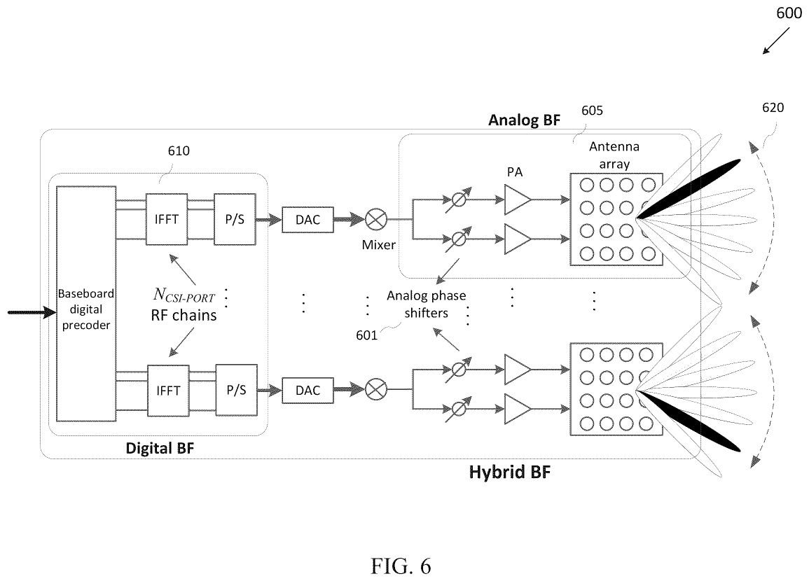

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In this disclosure, a beam is determined by either of:
A transmission configuration indicator (TCI) state, that establishes a quasi-colocation (QCL) relationship between a source reference signal (e.g., synchronization signal block (SSB) and/or CSI-RS) and a target reference signal; and/or
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

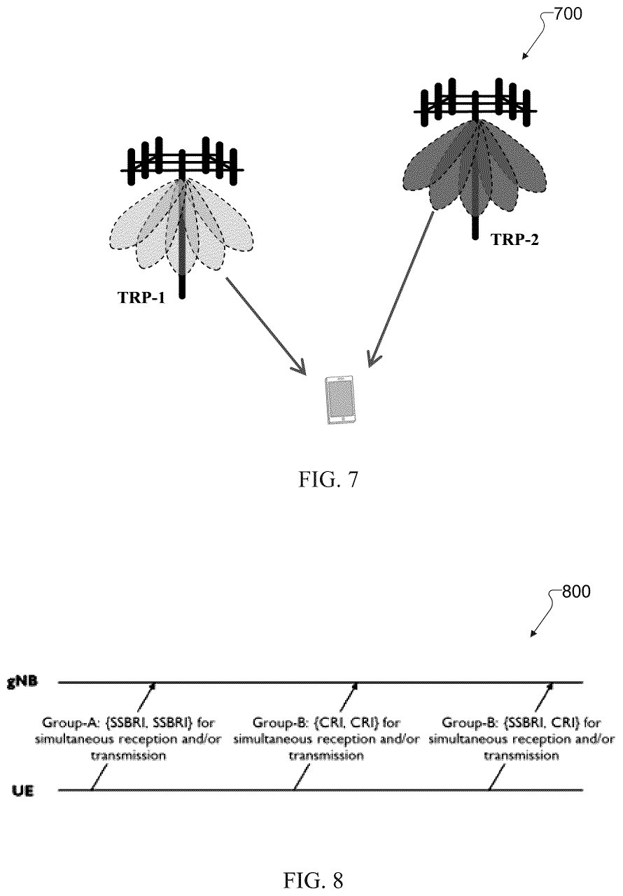

FIG. 7 illustrates an example system 700 for a multi-TRP according to embodiments of the present disclosure. For example, the system 700 may operate within the wireless network 100 in FIG. 1. This example is for illustration only and other embodiments can be used without departing from the scope of the present disclosure.

With referent to FIG. 7, a UE could simultaneously receive from multiple physically non-co-located TRPs various channels/RSs such as physical downlink control channels (PDCCHs) and/or physical downlink shared channels (PDSCHs) using either a single receive (RX) panel or multiple RX panels. In this disclosure, a RX panel could correspond to a set of RX antenna elements/ports at the UE (e.g., the 116), a set of measurement RS resources such as sounding reference signal (SRS) resources, a spatial domain RX filter or etc. Furthermore, a TRP in the multi-TRP system can represent a collection of measurement antenna ports, measurement RS resources and/or control resource sets (CORESETs). For example, a TRP could be associated with one or more of:
A plurality of CSI-RS resources;
A plurality of CRIs (CSI-RS resource indices/indicators);
A measurement RS resource set, for example, a CSI-RS resource set along with its indicator;
A plurality of CORESETs associated with a CORESETPoolIndex;
A plurality of CORESETs associated with a TRP-specific index/indicator/identity.

A cell/TRP could be a non-serving cell/TRP. In this disclosure, the non-serving cell(s) or the non-serving cell TRP(s) could have/broadcast different physical cell IDs (PCIs) and/or other higher layer signaling index values from that of the serving cell or the serving cell TRP (i.e., the serving cell PCI). In one example, the serving cell or the serving cell TRP could be associated with the serving cell ID (SCI) and/or the serving cell PCI. That is, for the inter-cell operation provided in the present disclosure, different cells/TRPs could broadcast different PCIs and/or one or more cells/TRPs (referred to/defined as non-serving cells/TRPs in the present disclosure) could broadcast different PCIs from that of the serving cell/TRP (i.e., the serving cell PCI) and/or one or more cells/TRPs are not associated with valid SCI (e.g., provided by the higher layer parameter ServCellIndex). In the present disclosure, a non-serving cell PCI can also be referred to as an additional PCI, another PCI, or a different PCI (with respect to the serving cell PCI).

This disclosure provides various design aspects related to beam measurement and/or reporting in a multi-TRP system, wherein a UE equipped with a single RX panel or multiple RX panels could simultaneously transmit to or receive from one or more TRPs. In particular, this disclosure specifies various beam/CSI report formats tailored for the simultaneous transmission/reception.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID.
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

Embodiments of the present disclosure recognize that there is a need to indicate to the UE a beam (i.e., a TCI state) for the transmission/reception of a PDCCH or a PDSCH. As described in the 3GPP Rel-17:
In one example, a MAC CE could be used to indicate to the UE a beam (i.e., a TCI state and/or a TCI state ID) for the transmission/reception of a PDCCH or a PDSCH.
In another example, a downlink control information (DCI) could be used to indicate to the UE a beam (i.e., a TCI state and/or a TCI state ID) for the transmission/reception of a PDCCH or a PDSCH.
For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based physical uplink shared channel (PUSCH) and dedicated physical uplink control channel (PUCCH) resources.

In a (single-DCI based) multi-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a set of one or more (e.g., N>1) TCI states/pairs of TCI states, wherein a TCI state could be a joint DL and UL TCI state or a separate DL TCI state provided by TCI-State/DLorJointTCI-State, or a separate UL TCI state provided by TCI-State/UL-TCIState. A pair of TCI states could include/contain a separate DL TCI state provided by TCI-State/DLorJointTCI-State or a separate UL TCI State provided by TCI-State/UL-TCIState, under the unified TCI framework.

For PDCCH reception or PDCCH candidate monitoring in a (single-DCI based) multi-TRP system, a UE could be configured/provided/indicated by the network (e.g., the network 130) via higher layer RRC signaling/parameter and/or MAC CE command and/or dynamic DCI based L1 signaling—e.g., in higher layer RRC signaling/parameter ControlResourceSet that configures a CORESET—a first indicator to indicate which one or more of the set of TCI states/pairs of TCI states indicated, e.g., by a TCI codepoint, in a beam indication DCI or MAC CE as specified herein in the present disclosure, to use/apply for receiving/monitoring the PDCCH(s)/PDCCH candidate(s) in the corresponding CORESET. For instance, for N=2 (i.e., a set of two TCI states/pairs of TCI states are indicated), the first indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET. ‘01’ indicates that the second TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET. ‘10’ indicates that the first and second TCI states among the set of TCI states/pairs of TCI states indicated, e.g., by a TCI codepoint, in a beam indication DCI or MAC CE as specified herein in the present disclosure, could be respectively used/applied for receiving/monitoring the PDCCH(s)/PDCCH candidate(s)—e.g., first and second PDCCH candidates—in the corresponding CORESET(s). ‘11’ indicates that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for receiving/monitoring the PDCCH(s)/PDCCH candidate(s)—e.g., first and second PDCCH candidates—in the corresponding CORESET(s), wherein the first and second PDCCH candidates could be received in search space sets that are higher layer linked via SearchSpaceLinking and/or the first and second PDCCH candidates carry the same/identical DCI payload. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PDSCH reception in a (single-DCI based) multi-TRP system, a UE could be configured/provided/indicated by the network via higher layer RRC signaling/parameter and/or MAC CE command and/or dynamic DCI based L1 signaling—e.g., in a DL DCI (e.g., DCI format 1_0/1_1/1_2) that schedules the PDSCH-a second indicator to indicate which one or more of the set of TCI states/pairs of TCI states indicated, e.g., by a TCI codepoint, in a beam indication DCI or MAC CE as specified herein in the present disclosure, to use/apply for receiving the PDSCH(s). For instance, for N=2 (i.e., a set of two TCI states/pairs of TCI states are indicated), the second indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH. ‘01’ indicates that the second TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH. ‘10’ indicates that the first and second TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH. ‘11’ indicates that the second and first TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, wherein the first and second PDSCHs could correspond to two PDSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PUCCH transmission in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter PUCCH-Config that configures PUCCH(s)/PUCCH resource(s)—a third indicator to indicate which one or more of the set of TCI states/pairs of TCI states indicated, e.g., by a TCI codepoint, in a beam indication DCI or MAC CE as specified herein in the present disclosure, to use/apply for transmitting the PUCCH(s)/PUCCH resource(s). For instance, for N=2 (i.e., a set of two TCI states/pairs of TCI states are indicated), the third indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s). ‘01’ indicates that the second TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s). ‘10’ indicates that the first and second TCI states among the set of TCI states/pairs of TCI states indicated, e.g., by a TCI codepoint, in a beam indication DCI or MAC CE as specified herein in the present disclosure, could be respectively used/applied for transmitting the PUCCH(s)/PUCCH resource(s)—e.g., first PUCCH/PUCCH resource and second PUCCH/PUCCH resource. ‘11’ indicates that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for transmitting the PUCCH(s)/PUCCH resource(s)—e.g., first PUCCH/PUCCH resource and second PUCCH/PUCCH resource, wherein the first and second PUCCHs/PUCCH resources could correspond to two PUCCH transmission occasions or repetitions in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

For PUSCH transmission in a (single-DCI based) multi-TRP system, a UE could be configured/provided/indicated by the network via higher layer RRC signaling/parameter and/or MAC CE command and/or dynamic DCI based L1 signaling—e.g., in an UL DCI (e.g., DCI format 0_0/0_1/0_2) that schedules the PUSCH-a fourth indicator to indicate which one or more of the set of TCI states/pairs of TCI states indicated, e.g., by a TCI codepoint, in a beam indication DCI or MAC CE as specified herein in the present disclosure, to use/apply for transmitting the PUSCH(s). For instance, for N=2 (i.e., a set of two TCI states/pairs of TCI states are indicated), the fourth indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH. ‘01’ indicates that the second TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH. ‘10’ indicates that the first and second TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH. ‘11’ indicates that the second and first TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, wherein the first and second PUSCHs could correspond to two PUSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states.

In a (multi-DCI based) multi-TRP system, a UE could be indicated/provided/configured by the network, e.g., in PDCCH-Config, two values (i.e., 0 and 1) of CORESET pool index (denoted by CORESETPoolIndex), wherein each CORESET could be configured with a value of CORESETPoolIndex. Furthermore, a UE could be indicated/provided/configured by the network, e.g., via a beam indication MAC CE or a DCI (e.g., via one or more TCI codepoints of one or more TCI fields in the corresponding DCI format 1_1/1_2 with or without DL assignment) associated to a CORESET pool index value (e.g., 0 or 1), one or more TCI states/pairs of TCI states for the same (or different) CORESET pool index value, wherein a TCI state could be a joint DL and UL TCI state or a separate DL TCI state provided by TCI-State/DLorJointTCI-State or a separate UL TCI state provided by TCI-State/UL-TCIState indicated for channels/signals such as PDCCH, PDSCH, PUCCH and PUSCH associated to the same (or different) CORESET pool index value. A pair of TCI states could include/contain a separate DL TCI state provided by TCI-State/DLorJointTCI-State or a separate UL TCI State provided by TCI-State/UL-TCIState indicated for channels/signals such as PDCCH, PDSCH, PUCCH and PUSCH associated to the same (or different) CORESET pool index value, under the unified TCI framework.

In the present disclosure, a UE could be configured/provided/indicated by the network (e.g., the network 130), e.g., via higher layer RRC signaling/parameter and/or MAC CE command and/or dynamic DCI based L1 signaling, to report in a single reporting instance/CSI report, one or more groups of resource indicators such as SSBRIs/CRIs (and therefore, the corresponding beam metrics including Layer 1 reference signal received powers (L1-RSRPs)/Layer 1 signal to interference and noise ratios (L1-SINRs)), wherein CSI-RS and/or SSB resources of a reported group could be received simultaneously by the UE and/or according to which, the UE could set their spatial domain transmit filter(s) for simultaneous transmission. When the UE is configured with groupBasedBeamReporting-r17 and/or groupBasedBeamReporting-r18:
In one example, the UE could report in a single reporting instance/CSI report, Ng (e.g., Ng≥0 or Ng≥1) groups of resource indicators including SSBRIs and/or CRIs (and therefore, their corresponding beam metrics including L1-RSRPs/L1-SINRs), wherein the CSI-RS and/or SSB resources of each group could be received simultaneously by the UE. Denote the maximum number of beam groups for simultaneous reception that can be reported in the same reporting instance/CSI-report by max_Ng, then Ng≤max_Ng. The UE could be provided/configured/indicated by the network, e.g., via higher layer RRC signaling/parameter and/or MAC CE command and/or dynamic DCI based L1 signaling, the value(s) of Ng and/or max_Ng. Alternatively, the UE could autonomously determine the value(s) of Ng and/or max_Ng, and report them to the network, e.g., in part of the beam/CSI report.
In another example, the UE could report in a single reporting instance/CSI report, Mg (e.g., Mg≥0 or Mg≥1) groups of resource indicators including SSBRIs and/or CRIs (and therefore, their corresponding beam metrics including L1-RSRPs/L1-SINRs), wherein the UE could simultaneously transmit various uplink channels/signals such as PUCCH(s), PUSCH(s) and/or SRS(s) according to the CSI-RS and/or SSB resources of each group. Denote the maximum number of beam groups for simultaneous transmission that can be reported in the same reporting instance/CSI-report by max_Mg, then Mg≤max_Mg. The UE could be provided/configured/indicated by the network, e.g., via higher layer RRC signaling/parameter and/or MAC CE command and/or dynamic DCI based L1 signaling, the value(s) of Mg and/or max_Mg. Alternatively, the UE could autonomously determine the value(s) of Mg and/or max_Mg, and report them to the network, e.g., in part of the beam/CSI report.
In yet another example, the UE could report in a single reporting instance/CSI report, a mixture of Ng (e.g., Ng≥0 or Ng≥1) first groups of resource indicators including SSBRIs and/or CRIs (and therefore, their corresponding beam metrics including L1-RSRPs/L1-SINRs), and Mg (e.g., Mg≥0 or Mg≥1) second groups of resource indicators including SSBRIs and/or CRIs (and therefore, their corresponding beam metrics including L1-RSRPs/L1-SINRs), wherein the CSI-RS and/or SSB resources of each first group could be received simultaneously by the UE, and the UE could simultaneously transmit various uplink channels/signals such as PUCCH(s), PUSCH(s) and/or SRS(s) according to the CSI-RS and/or SSB resources of each second group. Denote the maximum number of beam groups for simultaneous reception that can be reported in the same reporting instance/CSI-report by max_Ng and the maximum number of beam groups for simultaneous transmission that can be reported in the same reporting instance/CSI-report by max_Mg, then Ng≤max_Ng and Mg≤max_Mg. The UE could be provided/configured/indicated by the network, e.g., via higher layer RRC signaling/parameter and/or MAC CE command and/or dynamic DCI based L1 signaling, the value(s) of Ng and/or max_Ng and/or Mg and/or max_Mg and/or Kg=Ng+Mg and/or max_Kg-max_Ng+max_Mg. Alternatively, the UE (e.g., the 116) could autonomously determine the value(s) of Ng and/or max_Ng and/or Mg and/or max_Mg and/or Kg-Ng+Mg and/or max_Kg=max_Ng+max_Mg, and report them to the network, e.g., in part of the beam/CSI report. For this case, position(s)/ordering(s) of the first group of resource indicators and/or position(s)/ordering(s) of the second group of resource indicators in the reporting instance/CSI report could be determined or identified according to one of:
Fixed rule(s) in the system specifications and known to both the network and the UE sides. For example, the first reported group, the third reported group, the fifth reported group, and so on in the reporting instance/CSI report (i.e., the odd/odd-numbered/odd-indexed reported groups in the reporting instance/CSI report) could correspond to the first groups of resource indicators for simultaneous reception (or the second groups of resource indicators for simultaneous transmission), while the second reported group, the fourth reported group, the sixth reported group, and so on in the reporting instance/CSI report (i.e., the even/even-numbered/even-indexed reported groups in the reporting instance/CSI report) could correspond to the second groups of resource indicators for simultaneous transmission (or the first groups of resource indicators for simultaneous reception). For another example, the first Ng reported groups in the reporting instance/CSI report could correspond to the first groups of resource indicators for simultaneous reception, while the remaining reported groups in the same reporting instance/CSI report could correspond to the second groups of resource indicators for simultaneous transmission. Yet for another example, the first Mg reported groups in the reporting instance/CSI report could correspond to the second groups of resource indicators for simultaneous transmission, while the remaining reported groups in the same reporting instance/CSI report could correspond to the first groups of resource indicators for simultaneous reception.
Based one network's configuration or indication via higher layer RRC signaling(s)/parameter(s) and/or MAC CE command and/or dynamic DCI based L1 signaling. For example, the UE could be configured/indicated/provided by the network, e.g., via higher layer RRC signaling/parameter (e.g., in CSI-ResourceConfig, CSI-ReportConfig, or etc.) and/or MAC CE command and/or dynamic DCI based L1 signaling, a bitmap with each entry of the bitmap corresponding to a reported group in the reporting instance/CSI report. When/if an entry of the bitmap is set to ‘1’, the corresponding reported group could be for a first (or second) group of resource indicators for simultaneous reception (or transmission). When/if an entry of the bitmap is set to ‘0’, the corresponding reported group could be for a second (or first) group of resource indicators for simultaneous transmission (or reception). For another example, the UE could be configured/indicated/provided by the network, e.g., via higher layer RRC signaling/parameter (e.g., in CSI-ResourceConfig, CSI-ReportConfig, or etc.) and/or MAC CE command and/or dynamic DCI based L1 signaling, the (exact) position(s)/ordering(s) of the first groups of resource indicators and/or the second groups of resource indicators in the reporting instance/CSI report, e.g., in terms of index(es)/ID(s) of the corresponding reported group(s), index(es)/ID(s) of the corresponding reported resource indicator(s)/beam metric(s) and etc. in the reporting instance/CSI report. Yet for another example, the UE could be configured/indicated/provided by the network, e.g., via higher layer RRC signaling/parameter (e.g., in CSI-ResourceConfig, CSI-ReportConfig, or etc.) and/or MAC CE command and/or dynamic DCI based L1 signaling, to use the odd/odd-numbered/odd-indexed reported group(s) in the reporting instance/CSI report for the first (or second) group(s) of resource indicators for simultaneous reception (or transmission), and/or the even/even-numbered/even-indexed reported group(s) in the reporting instance/CSI report for the second (or first) group(s) of resource indicators for simultaneous transmission (reception). Yet for another example, the UE could be configured/indicated/provided by the network, e.g., via higher layer RRC signaling/parameter (e.g., in CSI-ResourceConfig, CSI-ReportConfig, or etc.) and/or MAC CE command and/or dynamic DCI based L1 signaling, to use the first Ng (or Mg) reported group(s) in the reporting instance/CSI report for the first (or second) group(s) of resource indicators for simultaneous reception (or transmission), and the remaining reported group(s) in the same reporting instance/CSI report for the second (or first) group(s) of resource indicators for simultaneous transmission (or reception). Yet for another example, the UE could be configured/indicated/provided by the network, e.g., via higher layer RRC signaling/parameter (e.g., in CSI-ResourceConfig, CSI-ReportConfig, or etc.) and/or MAC CE command and/or dynamic DCI based L1 signaling, one or more indicators each associated/corresponding to one or more reported groups in the reporting instance/CSI report; for this case, when/if an indicator from the one or more indicators is set to ‘1’ (or ‘0’) or ‘on’ (or ‘off’) or ‘enabled’ (or ‘disabled’) or configured/enabled/present, the UE could use/apply the corresponding/associated reported group(s) for the first (or second) group(s) of resource indicators for simultaneous reception (or transmission); otherwise, e.g., when/if an indicator from the one or more indicators is set to ‘0’ (or ‘1’) or ‘off’ (or ‘on’) or ‘disabled’ (or ‘enabled’) or not configured/enabled/present, the UE could use/apply the corresponding/associated reported group(s) for the second (or first) group(s) of resource indicators for simultaneous transmission (or reception).
Autonomously determined or identified by the UE, and reported by the UE to the network via uplink channel(s)/signal(s) such as uplink control information (UCI), MAC control element (CE), PUSCH, PUCCH, physical random access channel (PRACH) and etc. or in part of the beam/CSI report. For example, the UE could report/indicate to the network, e.g., in part of a/the CSI/beam report, a bitmap with each entry of the bitmap corresponding to a reported group in the reporting instance/CSI report. When/if an entry of the bitmap is set to ‘1’, the corresponding reported group could be for a first (or second) group of resource indicators for simultaneous reception (or transmission), and when/if an entry of the bitmap is set to ‘0’, the corresponding reported group could be for a second (or first) group of resource indicators for simultaneous transmission (or reception). For another example, the UE could report/indicate to the network, e.g., in part of a/the CSI/beam report, the (exact) position(s)/ordering(s) of the first groups of resource indicators and/or the second groups of resource indicators in the reporting instance/CSI report, e.g., in terms of index(es)/ID(s) of the corresponding reported group(s), index(es)/ID(s) of the corresponding reported resource indicator(s)/beam metric(s) and etc. in the reporting instance/CSI report. Yet for another example, the UE could indicate/report to the network, e.g., in part of a/the CSI/beam report, that the odd/odd-numbered/odd-indexed reported group(s) in the reporting instance/CSI report could be for the first (or second) group(s) of resource indicators for simultaneous reception (or transmission), and/or the even/even-numbered/even-indexed reported group(s) in the reporting instance/CSI report could be for the second (or first) group(s) of resource indicators for simultaneous transmission (reception). Yet for another example, the UE could indicate/report to the network, e.g., in part of a/the CSI/beam report, that the first Ng (or Mg) reported group(s) in the reporting instance/CSI report could be for the first (or second) group(s) of resource indicators for simultaneous reception (or transmission). The remaining reported group(s) in the same reporting instance/CSI report could be for the second (or first) group(s) of resource indicators for simultaneous transmission (or reception). Yet for another example, the UE could report/indicate to the network, e.g., in part of a/the CSI/beam report, one or more indicators each associated/corresponding to one or more reported groups in the reporting instance/CSI report; for this case, when/if an indicator from the one or more indicators is set to ‘1’ (or ‘0’) or ‘on’ (or ‘off’) or ‘enabled’ (or ‘disabled’) or provided/enabled/present, the corresponding/associated reported group(s) could be for the first (or second) group(s) of resource indicators for simultaneous reception (or transmission); otherwise, e.g., when/if an indicator from the one or more indicators is set to ‘0’ (or ‘1’) or ‘off’ (or ‘on’) or ‘disabled’ (or ‘enabled’) or not provided/enabled/present, the corresponding/associated reported group(s) could be for the second (or first) group(s) of resource indicators for simultaneous transmission (or reception).
In yet another example, the UE could report in a single reporting instance/CSI report, Kg (e.g., Kg≥0 or Kg≥1) groups of resource indicators including SSBRIs and/or CRIs (and therefore, their corresponding beam metrics including L1-RSRPs/L1-SINRs), wherein the CSI-RS and/or SSB resources of each (reported) group from the Kg (reported) groups could be received simultaneously by the UE, and the UE could simultaneously transmit various uplink channels/signals such as PUCCH(s), PUSCH(s) and/or SRS(s) according to the CSI-RS and/or SSB resources of each (reported) group from the Kg (reported) groups. Denote the maximum number of beam groups for both simultaneous reception and transmission that can be reported in the same reporting instance/CSI-report by max_Kg, then Kg≤max_Kg. The UE could be provided/configured/indicated by the network, e.g., via higher layer RRC signaling/parameter and/or MAC CE command and/or dynamic DCI based L1 signaling, the value(s) of Kg and/or max_Kg. Alternatively, the UE could autonomously determine the value(s) of Kg and/or max_Kg, and report them to the network, e.g., in part of the beam/CSI report.

Throughout the present disclosure, a group of resource indicators such as SSBRI(s) and/or CRI(s) is for simultaneous reception when/if the reference signal (RS) resources such as SSB(s) and/or CSI-RS(s) resources corresponding to the resource indicators in the group can be simultaneously received by the UE—e.g., using a single spatial domain receive filter or multiple spatial domain receive filters. Furthermore, a group of resource indicators such as SSBRI(s) and/or CRI(s) is for simultaneous transmission when/if the UE could set their spatial domain transmit filter(s) to simultaneously transmit the RS resources such as SSB(s) and/or CSI-RS(s) resources corresponding to the resource indicators in the group. In addition, throughout the present disclosure, a resource indicator type could correspond to a SSBRI or a CRI. For instance, a group of two resource indicators with different resource indicator types could be a group of a SSBRI and a CRI; a group of two resource indicators with the same resource indicator type could be a group of two SSBRIs or a group of two CRIs.

The UE could report/indicate to the network one or more capability signaling to indicate that, (i) the UE could (only) support or be capable of supporting simultaneous reception (e.g., of two beams from two TRPs) such that the UE could (only) be capable of reporting the group(s) of resource indicators (and therefore, their corresponding beam metrics) that can be simultaneously received by the UE following those specified herein in the present disclosure (e.g., following one or more examples described herein), and/or (ii) the UE could (only) support or be capable of supporting simultaneous transmission (e.g., of two beams from two panels) such that the UE could (only) be capable of reporting the group(s) of resource indicators (and therefore, their corresponding beam metrics) according to which the UE could set their spatial domain transmit filter(s) for simultaneous transmission of various uplink channels/signals such as PUCCH(s), PUSCH(s) and/or SRS(s) following those specified herein in the present disclosure (e.g., following one or more examples described herein), and/or (iii) the UE could (only) support or be capable of supporting both simultaneous reception (e.g., of two beams from two TRPs) and simultaneous transmission (e.g., of two beams from two panels) such that the UE could (only) be capable of reporting the first group(s) of resource indicators (and therefore, their corresponding beam metrics) that can be simultaneously received by the UE and the second group(s) of resource indicators (and therefore, their corresponding beam metrics) according to which the UE could set their spatial domain transmit filter(s) for simultaneous transmission of various uplink channels/signals such as PUCCH(s), PUSCH(s) and/or SRS(s) following those specified herein in the present disclosure (e.g., following one or more examples described herein), and/or (iv) the UE could (only) support or be capable of supporting both simultaneous reception (e.g., of two beams from two TRPs) and simultaneous transmission (e.g., of two beams from two panels) such that the UE could (only) be capable of reporting the group(s) of resource indicators (and therefore, their corresponding beam metrics) (a) that can be simultaneously received by the UE and (b) according to which the UE could set their spatial domain transmit filter(s) for simultaneous transmission of various uplink channels/signals such as PUCCH(s), PUSCH(s) and/or SRS(s) following those specified herein in the present disclosure (e.g., following one or more examples described herein).

Optionally, when the UE is configured with groupBasedBeamReporting-r17 and/or groupBasedBeamReporting-r18, and/or when the UE has reported the one or more capability signaling as specified herein in the present disclosure, the UE could be further configured/provided/indicated by the network, e.g., via higher layer RRC signaling/parameter and/or MAC CE command and/or dynamic DCI based L1 signaling (e.g., according to/based on the one or more reported UE capability signaling as specified herein in the present disclosure), to report in a single (or same) reporting instance/CSI report (i) only the group(s) of resource indicators (and therefore, their corresponding beam metrics) that can be simultaneously received by the UE following those specified herein in the present disclosure (e.g., following one or more examples described herein), and/or (ii) only the group(s) of resource indicators (and therefore, their corresponding beam metrics) according to which the UE could set their spatial domain transmit filter(s) for simultaneous transmission of various uplink channels/signals such as PUCCH(s), PUSCH(s) and/or SRS(s) following those specified herein in the present disclosure (e.g., following one or more examples described herein), and/or (iii) the first group(s) of resource indicators (and therefore, their corresponding beam metrics) that can be simultaneously received by the UE and the second group(s) of resource indicators (and therefore, their corresponding beam metrics) according to which the UE could set their spatial domain transmit filter(s) for simultaneous transmission of various uplink channels/signals such as PUCCH(s), PUSCH(s) and/or SRS(s) following those specified herein in the present disclosure (e.g., following one or more examples described herein), and/or (iv) the group(s) of resource indicators (and therefore, their corresponding beam metrics) (a) that can be simultaneously received by the UE and (b) according to which the UE could set their spatial domain transmit filter(s) for simultaneous transmission of various uplink channels/signals such as PUCCH(s), PUSCH(s) and/or SRS(s) following those specified herein in the present disclosure (e.g., following one or more examples described herein). Alternatively, the UE could autonomously determine/select to follow (i), (ii), (iii) and/or (iv) as specified above/herein in the present disclosure, and/or indicate to the network their determination(s)/selection(s), e.g., in part of the CSI/beam report.

In one example, the UE could be indicated/configured/provided by the network, e.g., via higher layer RRC signaling(s)/parameter(s)—e.g., in CSI-ResourceConfig/CSI-ReportConfig—and/or MAC CE command and/or dynamic DCI based L1 signaling, an indicator to indicate whether a/the CSI/beam report could include/contain/comprise (i), (ii), (iii) and/or (iv).
For example, the indicator could be a 1-bit indicator. When/if the one-bit indicator is set to ‘1’ (or ‘0’)—e.g., in the corresponding CSI resource setting provided by CSI-ResourceConfig or CSI reporting setting provided by CSI-ReportConfig, the UE could report in a/the reporting instance/CSI report one or more first groups of resource indicators for simultaneous reception according to those specified herein in the present disclosure and one or more second groups of resource indicators for simultaneous transmission according to those specified herein in the present disclosure, or report in a/the reporting instance/CSI report one or more groups of resource indicators for both simultaneous reception and transmission according to those specified herein in the present disclosure. When/if the one-bit is set to ‘0’ (or ‘1’)—e.g., in the corresponding CSI resource setting provided by CSI-ResourceConfig or CSI reporting setting provided by CSI-ReportConfig, the UE could report in a/the reporting instance/CSI report one or more groups of resource indicators for simultaneous reception according to those specified herein in the present disclosure, or report in a/the reporting instance/CSI report one or more groups of resource indicators for simultaneous transmission according to those specified herein in the present disclosure.
For another example, the indicator could be a 2-bit indicator. When/if the two-bit indicator is set to ‘00’ (‘01’, ‘10’ or ‘11’)—e.g., in the corresponding CSI resource setting provided by CSI-ResourceConfig or CSI reporting setting provided by CSI-ReportConfig, the UE could report in a/the reporting instance/CSI report one or more groups of resource indicators for simultaneous reception according to those specified herein in the present disclosure, when/if the two-bit indicator is set to ‘01’ (‘00’, ‘10’ or ‘11’)—e.g., in the corresponding CSI resource setting provided by CSI-ResourceConfig or CSI reporting setting provided by CSI-ReportConfig, the UE could report in a/the reporting instance/CSI report one or more groups of resource indicators for simultaneous transmission according to those specified herein in the present disclosure, when/if the two-bit indicator is set to ‘10’ (‘00’, ‘01’ or ‘11’)—e.g., in the corresponding CSI resource setting provided by CSI-ResourceConfig or CSI reporting setting provided by CSI-ReportConfig, the UE could report in a/the reporting instance/CSI report one or more first groups of resource indicators for simultaneous reception according to those specified herein in the present disclosure and one or more second groups of resource indicators for simultaneous transmission according to those specified herein in the present disclosure. When/if the two-bit indicator is set to ‘11’ (‘00’, ‘01’ or ‘10’)—e.g., in the corresponding CSI resource setting provided by CSI-ResourceConfig or CSI reporting setting provided by CSI-ReportConfig, the UE could report in a/the reporting instance/CSI report one or more groups of resource indicators for both simultaneous reception and transmission according to those specified herein in the present disclosure.

In one example, the UE could send to the network, e.g., in part of a/the CSI/beam report, an indicator to indicate whether a/the CSI/beam report could include/contain/comprise (i), (ii), (iii) and/or (iv).
For example, the indicator could be a 1-bit indicator. When/if the one-bit indicator is set to ‘1’ (or ‘0’) in the CSI/beam report, it could indicate that the CSI/beam report could contain/include/comprise one or more first groups of resource indicators for simultaneous reception according to those specified herein in the present disclosure and one or more second groups of resource indicators for simultaneous transmission according to those specified herein in the present disclosure, or the CSI/beam report could contain/include/comprise one or more groups of resource indicators for both simultaneous reception and transmission according to those specified herein in the present disclosure. When/if the one-bit is set to ‘0’ (or ‘1’) in the CSI/beam report, it could indicate that the CSI/beam report could only contain/include/comprise one or more groups of resource indicators for simultaneous reception according to those specified herein in the present disclosure, or the CSI/beam report could only contain/include/comprise one or more groups of resource indicators for simultaneous transmission according to those specified herein in the present disclosure.
For another example, the indicator could be a 2-bit indicator. When/if the two-bit indicator is set to ‘00’ (‘01’, ‘10’ or ‘11’) in the CSI/beam report, it could indicate that the CSI/beam could only contain/include/comprise one or more groups of resource indicators for simultaneous reception according to those specified herein in the present disclosure. When/if the two-bit indicator is set to ‘01’ (‘00’, ‘10’ or ‘11’) in the CSI/beam report, it could indicate that the CSI/beam could only contain/include/comprise one or more groups of resource indicators for simultaneous transmission according to those specified herein in the present disclosure. When/if the two-bit indicator is set to ‘10’ (‘00’, ‘01’ or ‘11’) in the CSI/beam report, it could indicate that the CSI/beam report could contain/include/comprise one or more first groups of resource indicators for simultaneous reception according to those specified herein in the present disclosure and one or more second groups of resource indicators for simultaneous transmission according to those specified herein in the present disclosure. When/if the two-bit indicator is set to ‘11’ (‘00’, ‘01’ or ‘10’) in the CSI/beam report, it could indicate that the CSI/beam report could contain/include/comprise one or more groups of resource indicators for both simultaneous reception and transmission according to those specified herein in the present disclosure.

FIG. 8 illustrates a diagram of example resource indicator/beam reporting groups 800 for simultaneous reception/transmission according to embodiments of the present disclosure. For example, resource indicator/beam reporting groups 800 for simultaneous reception/transmission can be utilized and reported by any of the UEs 111-116 of FIG. 1, such as the UE 116 of FIG. 3. This example is for illustration only and other embodiments can be used without departing from the scope of the present disclosure.

For periodic and semi-persistent CSI resource settings, when the UE is configured with groupBasedBeamReporting-r17 and/or groupBasedBeamReporting-r18 as specified herein in the present disclosure:
In one example, the number of CSI resource sets configured is S=2 (in the same CSI resource setting provided by CSI-ResourceConfig or separate CSI resource settings each provided by CSI-ResourceConfig) and the configured S=2 CSI resource sets could be used for the group based beam reporting for the simultaneous reception (e.g., according to one or more examples described herein) and the group based beam reporting for the simultaneous transmission (e.g., according to one or more examples described herein).
   For example, the configured S=2 CSI resource sets as described herein or specified herein in the present disclosure could correspond to two SSB resource sets-denoted by a first SSB resource set (e.g., with the lowest resource set ID/index) and a second SSB resource set (e.g., with the highest resource set ID/index)—each provided by a CSI-SSB-ResourceSet. For this case, the two reported SSBRIs in a reported group could be determined/selected, respectively from the two SSB resource sets, or from the first SSB resource set, or from the second SSB resource set. The SSB resources corresponding to the two reported SSBRIs in the reported group could be received simultaneously by the UE, and/or the UE could simultaneously transmit various uplink channels/signals such as PUCCH(s), PUSCH(s) and/or SRS(s) according to the SSB resources corresponding to the two reported SSBRIs in the reported group.
   For another example, the configured S=2 CSI resource sets as described herein or specified herein in the present disclosure could correspond to two non-zero power (NZP) CSI-RS resource sets-denoted by a first NZP CSI-RS resource set (e.g., with the lowest resource set ID/index) and a second NZP CSI-RS resource set (e.g., with the highest resource set ID/index)—each provided by nzp-CSI-RS-ResourceSet. For this case, the two reported CRIs in a reported group could be determined/selected, respectively, from the two NZP CSI-RS resource sets, or from the first NZP CSI-RS resource set, or from the second NZP CSI-RS resource set. The NZP CSI-RS resources corresponding to the two reported CRIs in the reported group could be received simultaneously by the UE, and/or the UE could simultaneously transmit various uplink channels/signals such as PUCCH(s), PUSCH(s) and/or SRS(s) according to the NZP CSI-RS resources corresponding to the two reported CRIs in the reported group.
   Yet for another example, the configured S=2 CSI resource sets as described herein or specified herein in the present disclosure could correspond to a SSB resource set provided by CSI-SSB-ResourceSet and a NZP CSI-RS resource set provided by nzp-CSI-RS-ResourceSet. For this case, the two reported SSBRI and CRI in a reported group could be determined/selected, respectively, from the SSB resource set and the NZP CSI-RS resource set, or the two reported CRIs in a reported group could be determined/selected from the NZP CSI-RS resource set, or the two reported SSBRIs in a reported group could be determined/selected from the SSB resource set. The SSB resource(s) and/or NZP CSI-RS resource(s) corresponding to the two reported SSBRI(s) and/or CRI(s) in the reported group could be received simultaneously by the UE, and/or the UE could simultaneously transmit various uplink channels/signals such as PUCCH(s), PUSCH(s) and/or SRS(s) according to the SSB resource(s) and/or NZP CSI-RS resource(s) corresponding to the two reported SSBRI(s) and/or CRI(s) in the reported group.

For the design examples specified herein in the present disclosure, the UE (e.g., the 116) could report, e.g., in a single/same reporting instance/CSI report, (i) one or more groups of SSBRIs for simultaneous reception and/or simultaneous transmission, and/or (ii) one or more groups of CRIs for simultaneous reception and/or simultaneous transmission, and/or (iii) one or more groups with each group comprising a SSBRI and a CRI for simultaneous reception and/or simultaneous transmission. The UE could be indicated/provided/configured by the network (e.g., the network 130), e.g., via higher layer RRC signaling and/or MAC CE command and/or dynamic DCI based L1 signaling, whether the UE could send one or more groups of resource indicators for simultaneous transmission and/or simultaneous reception according to (i) and/or (ii) and/or (iii) as specified herein in the present disclosure, based on the corresponding UE capability reporting/signaling. In one example, the UE could be indicated/configured by the network, e.g., via higher layer RRC signaling/parameter (e.g., by setting ‘reportQuantity’ in CSI-ReportConfig to ‘cri-ssbri-rsrp’) and/or MAC CE command and/or dynamic DCI based L1 signaling, to report in a/same reporting instance/CSI report, at least (iii) as described above/specified herein in the present disclosure. In another example, the UE could be indicated/configured by the network, e.g., via higher layer RRC signaling/parameter (e.g., by configuring/enabling ‘groupBasedBeamReporting-r18’ or ‘groupBasedBeamReporting-mix’) and/or MAC CE command and/or dynamic DCI based L1 signaling, to report in a/same reporting instance/CSI report, at least (i) and (ii) as described above/specified herein in the present disclosure. The corresponding UE capability reporting/signaling could include (a) whether the UE is capable of supporting simultaneous reception or simultaneous transmission of (or with respect to) a SSB resource and a NZP CSI-RS resource, and/or (b) whether the UE is capable of supporting simultaneous reception of two SSB resources and simultaneous transmission of two NZP CSI-RS resources, and/or (c) whether the UE is capable of supporting simultaneous reception of two NZP CSI-RS resources and simultaneous transmission of two SSB resources. With reference to FIG. 8, a conceptual example characterizing the design examples described/specified herein in the present disclosure is shown. The three groups of resource indicators as shown in FIG. 8, i.e., Group-A of {SSBRI, SSBRI}, Group-B of {CRI, CRI} and Group-C of {SSBRI, CRI}, could be for simultaneous reception and/or simultaneous transmission. The three groups of resource indicators could be reported in a/same reporting instance/CSI report or separate reporting instances/CSI reports, according to network's configuration(s)/indication(s) and/or UE's capability signaling(s)/reporting(s) as described/specified herein in the present disclosure.
In another example, the number of CSI resource sets configured is S=3—in the same CSI resource setting provided by CSI-ResourceConfig or separate CSI resource settings each provided by CSI-ResourceConfig (denoted by a first CSI resource set, a second CSI resource set and a third CSI resource set ordered by their resource set IDs/indexes in an ascending/descending order and/or their positions/orderings in the corresponding higher layer signaling/parameter of CSI resource setting(s)/configuration(s) and/or their RRC parameters descriptions in the system specifications and/or according to network's higher layer RRC signaling/parameter and/or MAC CE command and/or dynamic DCI based L1 signaling and/or etc.), and two of the configured S=3 CSI resource sets could be used for the group based beam reporting for the simultaneous reception (e.g., according to one or more examples described herein) and/or the group based beam reporting for the simultaneous transmission (e.g., according to one or more examples described herein).
   For example, two of the configured S=3 CSI resource sets could be used/applied for both of the group based beam reporting for the simultaneous reception (e.g., according to one or more examples described herein) and the group based beam reporting for the simultaneous transmission (e.g., according to one or more examples described herein). Which two of the configured S=3 CSI resource sets to use/apply could be fixed in the system specifications—e.g., the first and second CSI resource sets or the second and third CSI resource sets. Alternatively, the UE could be configured/indicated/provided by the network, e.g., via higher layer RRC signaling/parameter (e.g., via one or more bitmaps indicated/configured in the corresponding CSI resource setting(s) provided by CSI-ResourceConfig or CSI reporting setting(s) provided by CSI-ReportConfig) and/or MAC CE command and/or dynamic DCI based L1 signaling, which two of the configured S=3 CSI resource sets to use/apply.
   For another example, two of the configured S=3 CSI resource sets could be used/applied for the group based beam reporting for the simultaneous reception (e.g., according to one or more examples described herein) and another two of the configured S=3 CSI resource sets could be used/applied for the group based beam reporting for the simultaneous transmission (e.g., according to one or more examples described herein). Which two of the configured S=3 CSI resource sets to use/apply for the group based beam reporting for the simultaneous reception (e.g., according to one or more examples described herein) could be fixed in the system specifications—e.g., the first and second CSI resource sets or the second and third CSI resource sets. Alternatively, the UE could be configured/indicated/provided by the network, e.g., via higher layer RRC signaling/parameter (e.g., via one or more bitmaps indicated/configured in the corresponding CSI resource setting(s) provided by CSI-ResourceConfig or CSI reporting setting(s) provided by CSI-ReportConfig) and/or MAC CE command and/or dynamic DCI based L1 signaling, which two of the configured S=3 CSI resource sets to use/apply for the group based beam reporting for the simultaneous reception (e.g., according to one or more examples described herein). Furthermore, which two of the configured S=3 CSI resource sets to use/apply for the group based beam reporting for the simultaneous transmission (e.g., according to one or more examples described herein) could be fixed in the system specifications—e.g., the first and second CSI resource sets or the second and third CSI resource sets. Alternatively, the UE could be configured/indicated/provided by the network, e.g., via higher layer RRC signaling/parameter (e.g., via one or more bitmaps indicated/configured in the corresponding CSI resource setting(s) provided by CSI-ResourceConfig or CSI reporting setting(s) provided by CSI-ReportConfig) and/or MAC CE command and/or dynamic DCI based L1 signaling, which two of the configured S=3 CSI resource sets to use/apply for the group based beam reporting for the simultaneous transmission (e.g., according to one or more examples described herein).

For the design examples specified herein in the present disclosure, a configured CSI resource set (out of the configured S=3 CSI resource sets as specified/described herein in the present disclosure) could be a SSB resource set or a NZP CSI-RS resource set. Hence, the configured S=3 CSI resource sets could be (1) S=3 SSB resource sets, (2) S=3 NZP CSI-RS resource sets, (3) 2 SSB resource sets+1 NZP CSI-RS resource set, or (4) 1 SSB resource set+2 NZP CSI-RS resource sets. For these settings, the UE could report, e.g., in a single/same reporting instance/CSI report, (i) one or more groups of SSBRIs for simultaneous reception and/or simultaneous transmission, and/or (ii) one or more groups of CRIs for simultaneous reception and/or simultaneous transmission, and/or (iii) one or more groups with each group comprising a SSBRI and a CRI for simultaneous reception and/or simultaneous transmission. The UE could be indicated/provided/configured by the network, e.g., via higher layer RRC signaling and/or MAC CE command and/or dynamic DCI based L1 signaling, whether the UE could send one or more groups of resource indicators for simultaneous transmission and/or simultaneous reception according to (i) and/or (ii) and/or (iii) as specified herein in the present disclosure based on the corresponding UE capability reporting/signaling. In one example, the UE could be indicated/configured by the network, e.g., via higher layer RRC signaling/parameter (e.g., by setting ‘reportQuantity’ in CSI-ReportConfig to ‘cri-ssbri-rsrp’) and/or MAC CE command and/or dynamic DCI based L1 signaling, to report in a/same reporting instance/CSI report, at least (iii) as described above/specified herein in the present disclosure. In another example, the UE could be indicated/configured by the network, e.g., via higher layer RRC signaling/parameter (e.g., by configuring/enabling ‘groupBasedBeamReporting-r18’ or ‘groupBasedBeamReporting-mix’) and/or MAC CE command and/or dynamic DCI based L1 signaling, to report in a/same reporting instance/CSI report, at least (i) and (ii) as described above/specified herein in the present disclosure. The corresponding UE capability reporting/signaling could include (a) whether the UE is capable of supporting simultaneous reception or simultaneous transmission of (or with respect to) a SSB resource and a NZP CSI-RS resource, and/or (b) whether the UE is capable of supporting simultaneous reception of two SSB resources and simultaneous transmission of two NZP CSI-RS resources, and/or (c) whether the UE is capable of supporting simultaneous reception of two NZP CSI-RS resources and simultaneous transmission of two SSB resources.
In yet another example, the number of CSI resource sets configured is S=4 in the same CSI resource setting provided by CSI-ResourceConfig or separate CSI resource settings each provided by CSI-ResourceConfig (denoted by a first CSI resource set, a second CSI resource set, a third CSI resource set and a fourth CSI resource set ordered by their resource set IDs/indexes in an ascending/descending order and/or their positions/orderings in the corresponding higher layer signaling/parameter of CSI resource setting(s)/configuration(s) and/or their RRC parameters descriptions in the system specifications and/or according to network's higher layer RRC signaling/parameter and/or MAC CE command and/or dynamic DCI based L1 signaling and/or etc.). Two of the configured S=4 CSI resource sets could be used for the group based beam reporting for the simultaneous reception (e.g., according to one or more examples described herein) and/or the group based beam reporting for the simultaneous transmission (e.g., according to one or more examples described herein).
   For example, two of the configured S=4 CSI resource sets could be used/applied for both of the group based beam reporting for the simultaneous reception (e.g., according to one or more examples described herein) and the group based beam reporting for the simultaneous transmission (e.g., according to one or more examples described herein). Which two of the configured S=4 CSI resource sets to use/apply could be fixed in the system specifications—e.g., the first and second CSI resource sets or the third and fourth CSI resource sets. Alternatively, the UE could be configured/indicated/provided by the network, e.g., via higher layer RRC signaling/parameter (e.g., via one or more bitmaps indicated/configured in the corresponding CSI resource setting(s) provided by CSI-ResourceConfig or CSI reporting setting(s) provided by CSI-ReportConfig) and/or MAC CE command and/or dynamic DCI based L1 signaling, which two of the configured S=4 CSI resource sets to use/apply.
   For another example, two of the configured S=4 CSI resource sets could be used/applied for the group based beam reporting for the simultaneous reception (e.g., according to one or more examples described herein). Another two of the configured S=4 CSI resource sets could be used/applied for the group based beam reporting for the simultaneous transmission (e.g., according one or more examples described herein). Which two of the configured S=4 CSI resource sets to use/apply for the group based beam reporting for the simultaneous reception (e.g., according to one or more examples described herein) could be fixed in the system specifications—e.g., the first and second CSI resource sets or the third and fourth CSI resource sets. Alternatively, the UE could be configured/indicated/provided by the network, e.g., via higher layer RRC signaling/parameter (e.g., via one or more bitmaps indicated/configured in the corresponding CSI resource setting(s) provided by CSI-ResourceConfig or CSI reporting setting(s) provided by CSI-ReportConfig) and/or MAC CE command and/or dynamic DCI based L1 signaling, which two of the configured S=4 CSI resource sets to use/apply for the group based beam reporting for the simultaneous reception (e.g., according to one or more examples described herein). Furthermore, which two of the configured S=4 CSI resource sets to use/apply for the group based beam reporting for the simultaneous transmission (e.g., according to one or more examples described herein) could be fixed in the system specifications—e.g., the first and second CSI resource sets or the third and fourth CSI resource sets. Alternatively, the UE could be configured/indicated/provided by the network, e.g., via higher layer RRC signaling/parameter (e.g., via one or more bitmaps indicated/configured in the corresponding CSI resource setting(s) provided by CSI-ResourceConfig or CSI reporting setting(s) provided by CSI-ReportConfig) and/or MAC CE command and/or dynamic DCI based L1 signaling, which two of the configured S=4 CSI resource sets to use/apply for the group based beam reporting for the simultaneous transmission (e.g., according to one or more examples described herein).

For the design examples specified herein in the present disclosure, a configured CSI resource set (out of the configured S=4 CSI resource sets as specified/described herein in the present disclosure) could be a SSB resource set or a NZP CSI-RS resource set. Hence, the configured S=4 CSI resource sets could be (1) S=4 SSB resource sets, (2) S=4 NZP CSI-RS resource sets, (3) 3 SSB resource sets+1 NZP CSI-RS resource set, (4) 2 SSB resource sets+2 NZP CSI-RS resource sets, or (5) 1 SSB resource set+3 NZP CSI-RS resource sets. For these settings, the UE could report, e.g., in a single/same reporting instance/CSI report, (i) one or more groups of SSBRIs for simultaneous reception and/or simultaneous transmission, and/or (ii) one or more groups of CRIs for simultaneous reception and/or simultaneous transmission, and/or (iii) one or more groups with each group comprising a SSBRI and a CRI for simultaneous reception and/or simultaneous transmission. The UE could be indicated/provided/configured by the network, e.g., via higher layer RRC signaling and/or MAC CE command and/or dynamic DCI based L1 signaling, whether the UE could send one or more groups of resource indicators for simultaneous transmission and/or simultaneous reception according to (i) and/or (ii) and/or (iii) as specified herein in the present disclosure based on the corresponding UE capability reporting/signaling. In one example, the UE could be indicated/configured by the network, e.g., via higher layer RRC signaling/parameter (e.g., by setting ‘reportQuantity’ in CSI-ReportConfig to ‘cri-ssbri-rsrp’) and/or MAC CE command and/or dynamic DCI based L1 signaling, to report in a/same reporting instance/CSI report, at least (iii) as described above/specified herein in the present disclosure. In another example, the UE could be indicated/configured by the network, e.g., via higher layer RRC signaling/parameter (e.g., by configuring/enabling ‘groupBasedBeamReporting-r18’ or ‘groupBasedBeamReporting-mix’) and/or MAC CE command and/or dynamic DCI based L1 signaling, to report in a/same reporting instance/CSI report, at least (i) and (ii) as described above/specified herein in the present disclosure. The corresponding UE capability reporting/signaling could include (a) whether the UE is capable of supporting simultaneous reception or simultaneous transmission of (or with respect to) a SSB resource and a NZP CSI-RS resource, and/or (b) whether the UE is capable of supporting simultaneous reception of two SSB resources and simultaneous transmission of two NZP CSI-RS resources, and/or (c) whether the UE is capable of supporting simultaneous reception of two NZP CSI-RS resources and simultaneous transmission of two SSB resources.

Otherwise, i.e., when the UE is not configured with groupBasedBeamReporting-r17 and/or groupBasedBeamReporting-r18, the number of CSI resource sets configured could be limited to S=1.

For aperiodic CSI, and for periodic and semi-persistent CSI resource settings, each trigger state configured using the higher layer parameter (′SI-Aperiodic TriggerState is associated with one or multiple CSI-ReportConfig, where the (SI-ReportConfig configured with groupBasedBeamReporting-r17 and/or groupBasedBeamReporting-r18 is linked to periodic or semi-persistent, setting(s). When one resource setting is configured, the resource setting is given/provided by resourcesForChannelMeasurement for L1-RSRP measurement. In such as case, the number of configured CSI resource sets in the resource setting is S=2 or S=3 or S=4. The UE could follow those specified herein in the present disclosure, e.g., one or more examples described herein, to use/apply two of the configured 2 or 3 or 4 CSI resource sets for the group based beam reporting for the simultaneous reception (e.g., according to one or more examples described herein) and/or the group based beam reporting for the simultaneous transmission (e.g., according to one or more examples described herein).

For aperiodic CSI, and for aperiodic CSI resource settings, each trigger state configured using the higher layer parameter CSI-AperiodicTriggerState is associated with one or multiple CSI-ReportConfig where the (SI-ReportConfig configured with groupBasedBeamReporting-r17 and/or groupBasedBeamReporting-r18 is associated with:
Two resource sets denoted by resourcesForChannel and resourcesForChannel2 which correspond to the first and the second resource sets, respectively, for L1-RSRP measurement.
Three resource sets denoted by resourcesForChannel, resourcesForChannel2 and resourcesForChannel3 which correspond to the first, second, and third resource sets, respectively, for L1-RSRP measurement.
Four resource sets denoted by ResourcesForChannel, resourcesForChannel2, resourcesForChannel3 and resourcesForChannel4 which correspond to the first, second, third and fourth resource sets, respectively, for L1-RSRP measurement.

The UE could follow those specified herein in the present disclosure, e.g., one or more examples described herein, to use/apply two of the two, three or four resource sets for the group based beam reporting for the simultaneous reception (e.g., according to one or more examples described herein) and/or the group based beam reporting for the simultaneous transmission (e.g., according to one or more examples described herein).

According to the design examples specified herein in the present disclosure, a UE could autonomously determine to report in a/same reporting instance/CSI report, (1) at least a group of two SSBRIs for simultaneous reception, and/or (2) at least a group of two SSBRIs for simultaneous transmission, and/or (3) at least a group of two CRIs for simultaneous reception, and/or (4) at least a group of two CRIs for simultaneous transmission, and/or (5) at least a group of a SSBRI and a CRI for simultaneous reception, and/or (6) at least a group of a SSBRI and a CRI for simultaneous transmission. For this case, the UE could indicate to the network, e.g., in part of the CSI/beam report, their determination(s) of whether a/the beam report could contain/comprise/include (1) and/or (2) and/or (3) and/or (4) and/or (5) as specified above/herein in the present disclosure.

In one example, the UE could be indicated/configured/provided by the network, e.g., via higher layer RRC signaling(s)/parameter(s)—e.g., in CSI-ResourceConfig/CSI-ReportConfig—and/or MAC CE command and/or dynamic DCI based L1 signaling, an indicator to indicate whether a/the CSI/beam report could include/contain/comprise different groups of resource indicators that have different resource indicator types—e.g., a group of two SSBRIs and a group of two CRIs, and/or a group of two resource indicators that have different resource indicator types—e.g., a group of a SSBRI and a CRI.
For example, the indicator could be a 1-bit indicator. When/if the one-bit indicator is set to ‘1’ (or ‘0’)—e.g., in the corresponding CSI resource setting provided by CSI-ResourceConfig or CSI reporting setting provided by CSI-ReportConfig, the UE could report in a/the reporting instance/CSI report different groups of resource indicators that have different resource indicator types—e.g., a group of two SSBRIs and a group of two CRIs-according to those specified herein in the present disclosure, or report in a/the reporting instance/CSI report a group of resource indicators that have different resource indictor types—e.g., a group of a SSBRI and a CRI—according to those specified herein in the present disclosure. When/if the one-bit is set to ‘0’ (or ‘1’)—e.g., in the corresponding CSI resource setting provided by CSI-ResourceConfig or CSI reporting setting provided by CSI-ReportConfig, the UE could only report in a/the reporting instance/CSI report one or more groups of resource indicators that have the same resource indicator type—e.g., one or more groups of SSBRIs or one or more groups of CRIs-according to those specified herein in the present disclosure.
For another example, the indicator could be a 2-bit indicator. When/if the two-bit indicator is set to ‘00’ (‘01’, ‘10’ or ‘11’)—e.g., in the corresponding CSI resource setting provided by CSI-ResourceConfig or CSI reporting setting provided by CSI-ReportConfig, the UE could only report in a/the reporting instance/CSI report one or more groups of resource indicators that have the same resource indicator type—e.g., one or more groups of SSBRIs-according to those specified herein in the present disclosure. When/if the two-bit indicator is set to ‘01’ (‘00’, ‘10’ or ‘11’)—e.g., in the corresponding CSI resource setting provided by CSI-ResourceConfig or CSI reporting setting provided by CSI-ReportConfig, the UE could only report in a/the reporting instance/CSI report one or more groups of resource indicators that have the same resource indicator type—e.g., one or more groups of CRIs-according to those specified herein in the present disclosure. When/if the two-bit indicator is set to ‘10’ (‘00’, ‘01’ or ‘11’)—e.g., in the corresponding CSI resource setting provided by CSI-ResourceConfig or CSI reporting setting provided by CSI-ReportConfig, the UE could report in a/the reporting instance/CSI report different groups of resource indicators that have different resource indicator types—e.g., a group of two SSBRIs and a group of two CRIs-according to those specified herein in the present disclosure. When/if the two-bit indicator is set to ‘11’ (‘00’, ‘01’ or ‘10’)—e.g., in the corresponding CSI resource setting provided by CSI-ResourceConfig or CSI reporting setting provided by CSI-ReportConfig, the UE could report in a/the reporting instance/CSI report a group of resource indicator that have different resource indicator types—e.g., a group of a SSBRI and a CRI-according to those specified herein in the present disclosure.

In one example, the UE could send to the network, e.g., in part of a/the CSI/beam report, an indicator to indicate whether a/the CSI/beam report could include/contain/comprise different groups of resource indicators that have different resource indicator types—e.g., a group of two SSBRIs and a group of two CRIs, and/or a group of two resource indicators that have different resource indicator types—e.g., a group of a SSBRI and a CRI.
For example, the indicator could be a 1-bit indicator. When/if the one-bit indicator is set to ‘1’ (or ‘0’), it could indicate that a/the CSI/beam report could contain/include/comprise different groups of resource indicators that have different resource indicator types—e.g., a group of two SSBRIs and a group of two CRIs—according to those specified herein in the present disclosure. Or, a/the CSI/beam report could contain/include/comprise a group of resource indicators that have different resource indictor types—e.g., a group of a SSBRI and a CRI-according to those specified herein in the present disclosure. When/if the one-bit is set to ‘0’ (or ‘1’), it could indicate that a/the CSI/beam report could only contain/include/comprise one or more groups of resource indicators that have the same resource indicator type—e.g., one or more groups of SSBRIs or one or more groups of CRIs-according to those specified herein in the present disclosure.
For another example, the indicator could be a 2-bit indicator. When/if the two-bit indicator is set to ‘00’ (‘01’, ‘10’ or ‘11’), it could indicate that a/the CSI/beam report could only contain/include/comprise one or more groups of resource indicators that have the same resource indicator type—e.g., one or more groups of SSBRIs-according to those specified herein in the present disclosure. When/if the two-bit indicator is set to ‘01’ (‘00’, ‘10’ or ‘11’), it could indicate that a/the CSI/beam report could only contain/include/comprise one or more groups of resource indicators that have the same resource indicator type—e.g., one or more groups of CRIs-according to those specified herein in the present disclosure. When/if the two-bit indicator is set to ‘10’ (‘00’, ‘01’ or ‘11’), it could indicate that a/the CSI/beam report could contain/include/comprise different groups of resource indicators that have different resource indicator types—e.g., a group of two SSBRIs and a group of two CRIs-according to those specified herein in the present disclosure. When/if the two-bit indicator is set to ‘11’ (‘00’, ‘01’ or ‘10’), it could indicate that a/the CSI/beam report could contain/include/comprise a group of resource indicator that have different resource indicator types—e.g., a group of a SSBRI and a CRI—according to those specified herein in the present disclosure.

As specified herein in the present disclosure, when/if the UE (e.g., the 116) is configured with the higher layer parameter groupBasedBeamReporting-r17 and/or groupBasedBeamReporting-r18, the UE could report in a single reporting instance/CSI report Ng (e.g., Ng≥0 or Ng≥1) first group(s) of two CRIs and/or SSBRIs selecting one CSI-RS and/or SSB from each of the two CSI resource sets configured for the report setting and for the group based beam reporting for the simultaneous reception as specified herein in the present disclosure, where CSI-RS and/or SSB resources of each first group can be received simultaneously by the UE, and/or Mg (e.g., Mg≥0 or Mg≥1) second group(s) of two CRIs and/or SSBRIs selecting one CSI-RS and/or SSB from each of the two CSI resource sets configured for the report setting and for the group based beam reporting for the simultaneous transmission as specified herein in the present disclosure, where the UE could determine spatial domain transmit filter(s) according to CSI-RS and/or SSB resources of each second group to simultaneously transmit various uplink channels/signals such as PUCCH(s), PUSCH(s) and/or SRS(s).

In one example, when/if the UE could report, e.g., in a single/same reporting instance/CSI report, one or more first groups of two CRIs and/or SSBRIs for the simultaneous reception as specified herein in the present disclosure and one or more second groups of two CRIs and/or SSBRIs for the simultaneous transmission as specified herein in the present disclosure:
For example, the UE could report, e.g., in the same reporting instance/CSI report, one or more (one-bit) indicators each associated to/with a group of two reported CRIs and/or SSBRIs. When an (one-bit) indicator is set to ‘0’ (or ‘1’), the group of two reported CRIs and/or SSBRIs associated/corresponding to the (one-bit) indicator could correspond to a first group of two CRIs and/or SSBRIs for the simultaneous reception as specified herein in the present disclosure. When an (one-bit) indicator is set to ‘1’ (or ‘0’), the group of two reported CRIs and/or SSBRIs associated/corresponding to the (one-bit) indicator could correspond to a second group of two CRIs and/or SSBRIs for the simultaneous transmission as specified herein in the present disclosure.
For another example, the UE could report, e.g., in the same reporting instance/CSI report, one or more (one-bit) first indicators each associated to/with a group of two reported CRIs and/or SSBRIs. When a first indicator is present or reported or set to a valid value such as ‘0’ (or ‘1’), the group of two reported CRIs and/or SSBRIs associated/corresponding to the (one-bit) first indicator could correspond to a first group of two CRIs and/or SSBRIs for the simultaneous reception as specified herein in the present disclosure. Optionally, for a group of two reported CRIs and/or SSBRIs in the same reporting instance/CSI report, if there is no (one-bit) first indicator reported for it or associated to/with it, or the (one-bit) first indicator reported/associated to the group of two reported CRIs and/or SSBRIs is invalid (e.g., set to invalid value(s)), the group of two reported CRIs and/or SSBRIs could correspond to a second group of two CRIs and/or SSBRIs for the simultaneous transmission as specified herein in the present disclosure.
Yet for another example, the UE could report, e.g., in the same reporting instance/CSI report, one or more (one-bit) second indicators each associated to/with a group of two reported CRIs and/or SSBRIs. When a second indicator is present or reported or set to a valid value such as ‘0’ (or ‘1’), the group of two reported CRIs and/or SSBRIs associated/corresponding to the (one-bit) second indicator could correspond to a second group of two CRIs and/or SSBRIs for the simultaneous transmission as specified herein in the present disclosure. Optionally, for a group of two reported CRIs and/or SSBRIs in the same reporting instance/CSI report, if there is no (one-bit) second indicator reported for it or associated to/with it, or the (one-bit) second indicator reported/associated to the group of two reported CRIs and/or SSBRIs is invalid (e.g., set to invalid value(s)), the group of two reported CRIs and/or SSBRIs could correspond to a first group of two CRIs and/or SSBRIs for the simultaneous reception as specified herein in the present disclosure.
Yet for another example, the UE could use/apply one or more first entries/bits/bit positions of a reporting instance/CSI report to report the one or more first groups of two CRIs and/or SSBRIs as specified herein in the present disclosure and one or more second entries/bits/bit positions of a reporting instance/CSI report to report the one or more second groups of two CRIs and/or SSBRIs as specified herein in the present disclosure.
   In one example, the one or more first entries/bits/bit position and/or the one or more second entries/bits/bit positions of a reporting instance/CSI report as specified herein in the present disclosure could be fixed in the system specifications. For instance, the one or more first entries/bits/bit positions of a reporting instance/CSI report could correspond the first Ng (e.g., Ng≥0 or Ng≥1) entries/bits/bit positions of a reporting instance/CSI report, or the first Ng (e.g., Ng≥0 or Ng≥1) entries/bits/bit positions after one or more (reserved) entries/bits/bit positions (e.g., used for providing CSI resource set indicator(s)) of a reporting instance/CSI report, or the first Ng (e.g., Ng≥0 or Ng≥1) entries/bits/bit positions after the entries/bits/bit positions used for reporting the second group(s) of SSBRIs and/or CRIs of a reporting instance/CSI report, or the last Ng (e.g., Ng≥0 or Ng≥1) entries/bits/bit positions of a reporting instance/CSI report, or the odd/odd-numbered/odd-indexed entries/bits/bit positions of a reporting instance/CSI report, or the even/even-numbered/even-indexed entries/bits/bit positions of a reporting instance/CSI report. Alternatively, the one or more second entries/bits/bit positions of a reporting instance/CSI report could correspond the first Mg (e.g., Mg≥0 or Mg≥1) entries/bits/bit positions of a reporting instance/CSI report, or the first Mg (e.g., Mg≥0 or Mg≥1) entries/bits/bit positions after one or more (reserved) entries/bits/bit positions (e.g., used for providing CSI resource set indicator(s)) of a reporting instance/CSI report, or the first Mg (e.g., Mg≥0 or Mg≥1) entries/bits/bit positions after the entries/bits/bit positions used for reporting the second group(s) of SSBRIs and/or CRIs of a reporting instance/CSI report, or the last Mg (e.g., Mg≥0 or Mg≥1) entries/bits/bit positions of a reporting instance/CSI report, or the odd/odd-numbered/odd-indexed entries/bits/bit positions of a reporting instance/CSI report, or the even/even-numbered/even-indexed entries/bits/bit positions of a reporting instance/CSI report.
   In another example, the UE could be provided/indicated/configured by the network, e.g., via higher layer RRC signaling/parameter and/or MAC CE command and/or dynamic DCI based L1 signaling, information related to (which of) the entries/bits/bit positions of a reporting instance/CSI report that the UE could use/apply for reporting the first group(s) of two SSBRIs and/or CRIs as specified herein in the present disclosure and/or (which of) the entries/bits/bit positions of a reporting instance/CSI report that the UE could use/apply for reporting the second group(s) of two SSBRIs and/or CRIs as specified herein in the present disclosure. The information could be in form of one-bit (flag) indicator(s), multi-bit indicator(s), bitmap(s)—e.g., each bit/bit position of a bitmap could correspond to an entry/bit/bit position of a reporting instance/CSI report, and/or etc. Furthermore, the information could include the number of the first group(s) of two SSBRIs and/or CRIs for the simultaneous reception as specified herein in the present disclosure—e.g., Ng, the number of the second group(s) of two SSBRIs and/or CRIs for the simultaneous transmission as specified herein in the present disclosure—e.g., Mg, the starting/ending entry/bit/bit position of the reporting instance/CSI report for the first group(s) of two SSBRIs and/or CRIs as specified herein in the present disclosure, the starting/ending entry/bit/bit position of the reporting instance/CSI report for the second group(s) of two SSBRIs and/or CRIs and/or etc.
   In yet another example, the UE could autonomously identify/determine (which of) the entries/bits/bit positions of a reporting instance/CSI report that the UE would use/apply for reporting the first group(s) of two SSBRIs and/or CRIs as specified herein in the present disclosure and/or (which of) the entries/bits/bit positions of a reporting instance/CSI report that the UE would use/apply for reporting the second group(s) of two SSBRIs and/or CRIs as specified herein in the present disclosure. Furthermore, the UE could indicate to the network, e.g., in part of the same reporting instance/CSI report, information related to the identified/determined entries/bits/bit positions of the reporting instance/CSI report used/applied for reporting the first and/or second group(s) of SSBRIs and/or CRIs as specified herein in the present disclosure. The information could be in form of one-bit (flag) indicator(s), multi-bit indicator(s), bitmap(s)—e.g., each bit/bit position of a bitmap could correspond to an entry/bit/bit position of a reporting instance/CSI report, and/or etc. Furthermore, the information could include the number of the first group(s) of two SSBRIs and/or CRIs for the simultaneous reception as specified herein in the present disclosure—e.g., Ng, the number of the second group(s) of two SSBRIs and/or CRIs for the simultaneous transmission as specified herein in the present disclosure—e.g., Mg, the starting/ending entry/bit/bit position of the reporting instance/CSI report for the first group(s) of two SSBRIs and/or CRIs as specified herein in the present disclosure, the starting/ending entry/bit/bit position of the reporting instance/CSI report for the second group(s) of two SSBRIs and/or CRIs and/or etc.

The UE could report, in the same reporting instance/CSI report, the one or more first groups of CRIs and/or SSBRIs for the simultaneous reception as specified herein in the present disclosure followed by the one or more second groups of CRIs and/or SSBRIs for the simultaneous transmission as specified herein in the present disclosure. Alternatively, the UE could report, in the same reporting instance/CSI report, the one or more second groups of CRIs and/or SSBRIs for the simultaneous transmission as specified herein in the present disclosure, followed by the one or more first groups of CRIs and/or SSBRIs for the simultaneous reception as specified herein in the present disclosure.

According to the design examples specified herein in the present disclosure, when/if one or more of the following conditions are achieved/satisfied:
The UE is configured/indicated/provided by the network (e.g., the network 130), e.g., via higher layer RRC signaling(s)/parameter(s) and/or MAC CE command and/or dynamic DCI based L1 signaling, to report in a/same reporting instance/CSI report one or more first groups of resource indicators for simultaneous reception as specified herein in the present disclosure and one or more second groups of resource indicators for simultaneous transmission as specified herein in the present disclosure.
   In one example, the network's configuration(s)/indication(s), e.g., via/in CSI-ResourceConfig and/or CSI-ReportConfig, could include/contain/comprise a number (e.g., Ng≥1) of first group(s) of resource indicators/beam metrics to be reported (that can be reported) in a/the reporting instance/CSI report and/or a number (e.g., Mg≥1) of second group(s) of resource indicators/beam metrics to be reported (that can be reported) in a/the reporting instance/CSI report.
   In another example, the network's configuration(s)/indication(s), e.g., via/in CSI-ResourceConfig and/or CSI-ReportConfig, could include/contain/comprise a number (e.g., Kg≥1) of group(s) of resource indicators/beam metrics to be reported (that can be reported) in a/the reporting instance/CSI report. The value of Kg is greater than or equal to (or less than or equal to) a threshold. The threshold could be: (1) a fixed value specified in system specifications, (2) determined according to network's configuration(s)/indication(s) via higher layer RRC signaling and/or MAC CE command and/or dynamic DCI based L1 signaling and/or (3) autonomously determined by the UE and reported by the UE to the network.
   In yet another example, the network's configuration(s)/indication(s), e.g., via/in CSI-ResourceConfig and/or CSI-ReportConfig, could include/contain/comprise a dedicated higher layer parameter, e.g., denoted by groupBasedBeamReporting-mix, configured/enabled/set to ‘enabled’. Optionally, the network's configuration(s)/indication(s), e.g., via/in CSI-ResourceConfig and/or CSI-ReportConfig, could include/contain/comprise a dedicated indicator, e.g., an (one-bit) indicator set to ‘1’ or ‘on’ or ‘enabled’.
   In yet another example, the network's configuration(s)/indication(s), e.g., via/in CSI-ResourceConfig and/or CSI-ReportConfig, could include/contain/comprise the higher layer parameter ‘reportQuantity’ set to ‘ssbri-cri-rsrp’ or other equivalent value(s) to enable the group based beam reporting for both simultaneous reception and simultaneous transmission as specified herein in the present disclosure.
The UE could send to the network, e.g., in part of a/the reporting instance/CSI report, one or more indicators to indicate to the network that the corresponding beam/CSI report contains/includes/comprises one or more first groups of resource indicators for simultaneous reception as specified herein in the present disclosure and one or more second groups of resource indicators for simultaneous transmission as specified herein in the present disclosure. For instance, the UE could send to the network, e.g., in part of a/the reporting instance/CSI report, a one-bit indicator; when/if the one-bit indicator is set to ‘1’ (or ‘0’), the corresponding beam/CSI report contains/includes/comprises a mixture of one or more first groups of resource indicators for simultaneous reception as specified herein in the present disclosure and one or more second groups of resource indicators for simultaneous transmission as specified herein in the present disclosure.

The ordering(s)/position(s) of the first group(s) of resource indicators and/or the second group(s) of resource indicators in a/the reporting instance/CSI report could follow fixed/predefined/predetermined rule(s) according to/based on system specifications.
For example, the one or more first entries/bits/bit position and/or the one or more second entries/bits/bit positions of a reporting instance/CSI report as specified herein in the present disclosure could be fixed in the system specifications. For instance, the one or more first entries/bits/bit positions of a reporting instance/CSI report could correspond the first Ng (e.g., Ng≥0 or Ng≥1) entries/bits/bit positions of a reporting instance/CSI report, or the first Ng (e.g., Ng≥0 or Ng≥1) entries/bits/bit positions after one or more (reserved) entries/bits/bit positions (e.g., used for providing CSI resource set indicator(s)) of a reporting instance/CSI report, or the first Ng (e.g., Ng≥0 or Ng≥1) entries/bits/bit positions after the entries/bits/bit positions used for reporting the second group(s) of SSBRIs and/or CRIs of a reporting instance/CSI report, or the last Ng (e.g., Ng≥0 or Ng≥1) entries/bits/bit positions of a reporting instance/CSI report, or the odd/odd-numbered/odd-indexed entries/bits/bit positions of a reporting instance/CSI report, or the even/even-numbered/even-indexed entries/bits/bit positions of a reporting instance/CSI report. Alternatively, the one or more second entries/bits/bit positions of a reporting instance/CSI report could correspond the first Mg (e.g., Mg≥0 or Mg≥1) entries/bits/bit positions of a reporting instance/CSI report, or the first Mg (e.g., Mg≥0 or Mg≥1) entries/bits/bit positions after one or more (reserved) entries/bits/bit positions (e.g., used for providing CSI resource set indicator(s)) of a reporting instance/CSI report, or the first Mg (e.g., Mg≥0 or Mg≥1) entries/bits/bit positions after the entries/bits/bit positions used for reporting the second group(s) of SSBRIs and/or CRIs of a reporting instance/CSI report, or the last Mg (e.g., Mg≥0 or Mg≥1) entries/bits/bit positions of a reporting instance/CSI report, or the odd/odd-numbered/odd-indexed entries/bits/bit positions of a reporting instance/CSI report, or the even/even-numbered/even-indexed entries/bits/bit positions of a reporting instance/CSI report.
For another example, the first reported group, the third reported group, the fifth reported group, and so on in the reporting instance/CSI report (i.e., the odd/odd-numbered/odd-indexed reported groups in the reporting instance/CSI report) could correspond to the first groups of resource indicators for simultaneous reception (or the second groups of resource indicators for simultaneous transmission), while the second reported group, the fourth reported group, the sixth reported group, and so on in the reporting instance/CSI report (i.e., the even/even-numbered/even-indexed reported groups in the reporting instance/CSI report) could correspond to the second groups of resource indicators for simultaneous transmission (or the first groups of resource indicators for simultaneous reception). For another example, the first Ng reported groups in the reporting instance/CSI report could correspond to the first groups of resource indicators for simultaneous reception, while the remaining reported groups in the same reporting instance/CSI report could correspond to the second groups of resource indicators for simultaneous transmission. Yet for another example, the first Mg reported groups in the reporting instance/CSI report could correspond to the second groups of resource indicators for simultaneous transmission, while the remaining reported groups in the same reporting instance/CSI report could correspond to the first groups of resource indicators for simultaneous reception.

Throughout the present disclosure, an entry/bit/bit position in a reporting instance/CSI report could correspond to or could be equivalent to a reported group of resource indicators in a reporting instance/CSI report. Furthermore, throughout the present disclosure, the ordering(s)/position(s) of the one or more groups of beam metrics (e.g., each beam metric could correspond to a L1-RSRP or L1-SINR) in a reporting instance/CSI report could follow the ordering(s)/position(s) of their corresponding/associated one or more groups of resource indicators in the same reporting instance/CSI report. In addition, a reporting instance/CSI report could first contain/include/comprise (e.g., using the first Ng, Mg or Kg entries/bits/bit positions in the reporting instance/CSI report, wherein Ng, Mg or Kg≥1) the one or more groups of resource indicators as specified herein in the present disclosure followed by their corresponding/associated one or more groups of beam metrics; alternatively, a reporting instance/CSI report could first contain/include/comprise (e.g., using the first Ng, Mg or Kg entries/bits/bit positions in the reporting instance/CSI report, wherein Ng, Mg or Kg≥1) the one or more groups of beam metrics as specified herein in the present disclosure followed by their corresponding/associated one or more groups of resource indicators.

In one example, if the UE is configured with the higher layer parameter groupBasedBeamReporting-r17, the UE could report in a single reporting instance/CSI report up to nrofReportedGroups, if configured, e.g., Ng group(s) of two CRIs and/or SSBRIs selecting one CSI-RS and/or SSB from each of the two CSI resource sets for the report setting, where CSI-RS and/or SSB resources of each group can be received simultaneously by the UE, and 0≤Ng≤nrofReportedGroups or Ng∈{0, 1, . . . , nrofReportedGroups}. The UE could autonomously determine the value(s) of Ng, and report to the network the value(s)/information of Ng, e.g., in part of the CSI/beam report as specified herein in the present disclosure. More specifically, for a two-part UCI design/report/reporting setting/report structure/report format, the UE could report the value(s)/information of Ng in part 1 of the two-part UCI report. For Ng=0 or Ng=nrofReportedGroups, i.e., when/if the UE determines that Ng=0 or Ng=nrofReportedGroups, the UE may not report to the network the value(s)/information of Ng, e.g., in part of the CSI/beam report as specified herein in the present disclosure. That is, when/if 1≤Ng<nrofReportedGroups (or Ng∈{1, . . . , nrofReportedGroups}), or equivalently, when/if the UE determines that 1≤Ng<nrofReportedGroups (or Ng∈{1, . . . , nrofReportedGroups}), the UE could report to the network the value(s)/information of Ng, e.g., in part of the CSI/beam report as specified herein in the present disclosure.
For Ng=0, the UE may not report, e.g., in a single reporting instance/CSI report, any resource indicator(s) such as SSBRI(s)/CRI(s) and/or beam metric(s) such as L1-RSRP(s)/L1-SINR(s). The UE could still report, e.g., in the reporting instance/CSI report, the 1-bit resource set indicator, wherein the 1-bit resource set indicator could be set to a fixed value such as 0 or 1. For this case, setting the value of the 1-bit resource set indicator as ‘0’ (or ‘1’) would mean/indicate that there is no resource indicator(s) such as SSBRI(s)/CRI(s) and/or beam metric(s) such as L1-RSRP(s)/L1-SINR(s) reported in the reporting instance/CSI report. Optionally, the UE could indicate to the network, e.g., by/via incorporating an indicator in the CSI/beam report, that no resource indicator(s) and/or beam metric(s) as specified herein in the present disclosure is reported in the CSI/beam report—e.g., when/if the 1-bit resource indicator is not reported/present in the CSI/beam report.
For 1≤Ng<nrofReportedGroups (or Ng∈{1, . . . , nrofReportedGroups}), the UE could report in a single reporting instance/CSI report, Ng group(s) of two CRIs or SSBRIs (and therefore, their corresponding beam metrics such as L1-RSRPs and/or L1-SINRs) selecting one CSI-RS or SSB from each of the two CSI resource sets for the report setting, where CSI-RS and/or SSB resources of each group can be received simultaneously by the UE. For this case, the UE could determine the CSI report (and therefore, its contents/payloads) following those provided in TABLE 1 and TABLE 2 in the present disclosure.
   TABLE 1: CRI, SSBRI, SINR and CapabilityIndex (Kₛ^{CSI-RS} is the number of CSI-RS resources in the corresponding resource set, and Kₛ^{SSB} is the configured number of synchronization signal/physical broadcast channel (SS/PBCH) blocks in the corresponding resource set for reporting ‘ssb-Index-RSRP’)

| Field | Bitwidth |
|---|---|
| CRI | [log₂ Kₛ^{CSI-RS}] |
| SSBRI | [log₂ Kₛ^{SSB}] |
| RSRP | 7 |
| Differential RSRP | 4 |

TABLE 2
Mapping order of CSI fields of one report for
group-based CRI/RSRP or SSBRI/RSRP reporting

| CSI report | |
|---|---|
| number | CSI fields |
| CSI report #n | Resource set indicator |
| | CRI or SSBRI #1 of 1st resource group as in TABLE 1, if reported |
| | CRI or SSBRI #2 of 1st resource group as in TABLE 1, if reported |
| | CRI or SSBRI #1 of 2nd resource group as in TABLE 1, if reported |
| | CRI or SSBRI #2 of 2nd resource group as in TABLE 1, if reported |
| | CRI or SSBRI #1 of 3rd resource group as in TABLE 1, if reported |
| | CRI or SSBRI #2 of 3rd resource group as in TABLE 1, if reported |
| | CRI or SSBRI #1 of 4th resource group as in TABLE 1, if reported |
| | CRI or SSBRI #2 of 4th resource group as in TABLE 1, if reported |
| | RSRP of CRI or SSBRI #1 of 1st resource group as in TABLE 1 |
| | Differential RSRP of CRI or SSBRI #2 of 1st resource group as in |
| | TABLE 1 |
| | Differential RSRP of CRI or SSBRI #1 of 2nd resource group as in |
| | TABLE 1, if reported |
| | Differential RSRP of CRI or SSBRI #2 of 2nd resource group as in |
| | TABLE 1, if reported |
| | Differential RSRP of CRI or SSBRI #1 of 3rd resource group as in |
| | TABLE 1, if reported |
| | Differential RSRP of CRI or SSBRI #2 of 3rd resource group as in |
| | TABLE 1, if reported |
| | Differential RSRP of CRI or SSBRI #1 of 4th resource group as in |
| | TABLE 1, if reported |
| | Differential RSRP of CRI or SSBRI #2 of 4th resource group as in |

TABLE 1, if reported

In one example, if the UE (e.g., the 116) is configured with the higher layer parameter groupBasedBeamReporting-r17, the UE could report in a single reporting instance/CSI report nrofReportedRS, if higher layer configured, different CRI(s) or SSBRI(s)—and their corresponding L1-RSRP(s) or L1-SINR(s)—for each report setting. Optionally, the UE could indicate to the network, e.g., via/by sending/incorporating an indicator in part of the CSI/beam report, that the resource indicator(s) such as SSBRI(s)/CRI(s) and the corresponding beam metric(s) such as L1-RSRP(s)/L1-SINR(s) reported in the reporting instance/CSI report is not for the configured group based beam reporting (or equivalently, that the resource indicator(s) and the corresponding beam metric(s) reported in the reporting instance/CSI report is for non-group based beam reporting, e.g., for STRP operation).

In one example, if the UE is configured with the higher layer parameter groupBasedBeamReporting-r17, the UE could report in a single reporting instance/CSI report two different CRI(s) or SSBRI(s)—and their corresponding L1-RSRP(s) or L1-SINR(s)—for each report setting, where CSI-RS and/or SSB resources can be received simultaneously by the UE either with a single spatial domain receive filter, or with multiple simultaneous spatial domain receive filters. Optionally, the UE could indicate to the network (e.g., the network 130), e.g., via/by sending/incorporating an indicator in part of the CSI/beam report, that the resource indicator(s) such as SSBRI(s)/CRI(s) and the corresponding beam metric(s) such as L1-RSRP(s)/L1-SINR(s) reported in the reporting instance/CSI report is not for the configured group based beam reporting specified in Rel-17 (or equivalently, that the resource indicator(s) and the corresponding beam metric(s) reported in the reporting instance/CSI report is for group based beam reporting specified in Rel-16).

In one embodiment, when/if a beam/CSI report includes/contains/comprises one or more first groups of resource indicators for simultaneous reception according to those specified herein in the present disclosure and one or more second groups of resource indicators for simultaneous transmission according to those specified herein in the present disclosure, differential beam reporting such as differential RSRP reporting or differential SINR reporting could be applied to either the first group(s) of resource indicators for simultaneous reception according to those specified herein in the present disclosure or the second group(s) of resource indicators for simultaneous transmission according to those specified herein in the present disclosure, or both of the first and second groups of resource indicators for simultaneous reception/transmission, in a/the reporting instance/CSI report.
In one example, the UE could be indicated/configured/provided by the network, e.g., via higher layer RRC signaling/parameter (e.g., via/in CSI-ResourceConfig or CSI-ReportConfig) and/or MAC CE command and/or dynamic DCI based L1 signaling, one or more indicators to enable/disable or turn on/off the differential reporting for the first group(s) of resource indicators for simultaneous reception and/or for the second group(s) of resource indicators for simultaneous transmission, in a/the reporting instance/CSI report.
   For example, the UE could be indicated/configured/provided by the network, e.g., via higher layer RRC signaling/parameter (e.g., via/in CSI-ResourceConfig or CSI-ReportConfig) and/or MAC CE command and/or dynamic DCI based L1 signaling, an (one-bit) indicator to enable/disable or turn on/off the differential beam reporting for the mixed groups of resource indicators for simultaneous transmission and reception. For instance, when/if the (one-bit) indicator is set to ‘1’ (or ‘0’), the differential beam reporting could be enabled/applied for both of the first and second groups of resource indicators, wherein as specified herein in the present disclosure, the first group(s) of resource indicators are for simultaneous reception and the second group(s) of resource indicators are for simultaneous transmission; when/if the (one-bit) indicator is set to ‘0’ (‘1’), the differential beam reporting could be enabled/applied for either the first group(s) of resource indicators for simultaneous reception or the second group(s) of resource indicators for simultaneous transmission, or enabled/applied for none of the first or second group(s) of resource indicators for simultaneous reception or transmission.
   For another example, the UE could be indicated/configured/provided by the network, e.g., via higher layer RRC signaling/parameter (e.g., via/in CSI-ResourceConfig or CSI-ReportConfig) and/or MAC CE command and/or dynamic DCI based L1 signaling, an (two-bit) indicator to enable/disable or turn on/off the differential beam reporting for the first and/or second group(s) of resource indicators. For instance, when/if the (two-bit) indicator is set to ‘00’ (‘01’, ‘10’ or ‘11’), the differential beam reporting could be enabled/applied for only the first group(s) of resource indicators for simultaneous reception in a/the reporting instance/CSI report. When/if the (two-bit) indicator is set to ‘01’ (‘00’, ‘10’ or ‘11’), the differential beam reporting could be enabled/applied for only the second group(s) of resource indicators for simultaneous transmission in a/the reporting instance/CSI report. When/if the (two-bit) indicator is set to ‘10’ (‘00’, ‘01’ or ‘11’), the differential beam reporting could be enabled/applied for both the first and second groups of resource indicators in a/the reporting instance/CSI report. When/if the (two-bit) indicator is set to ‘11’ (‘00’, ‘01’, ‘10’ or ‘11’), the differential beam reporting may not be enabled/applied to either the first group(s) or the second group(s) of resource indicators in a/the reporting instance/CSI report.
   Yet for another example, when/if the UE is higher layer configured/provided/indicated by the network, e.g., via/in CSI-ResourceConfig or CSI-ReportConfig, a higher layer parameter—e.g., denoted by DiffReportingSimTRX (e.g., set to ‘enabled’), the differential beam reporting could be enabled/applied for both the first and second groups of resource indicators in a/the reporting instance/CSI report; otherwise, i.e., when/if the higher layer parameter—e.g., denoted by DiffReportingSimTRX is not configured/enabled/set to ‘enabled’, the differential beam reporting could be enabled/applied for either the first group(s) of resource indicators for simultaneous reception or the second group(s) of resource indicators for simultaneous transmission, or enabled/applied for none of the first or second group(s) of resource indicators for simultaneous reception or transmission. Optionally, when/if the UE is higher layer configured/provided/indicated by the network, e.g., via/in CSI-ResourceConfig or CSI-ReportConfig, a higher layer parameter—e.g., denoted by DiffReportingSimRX (e.g., set to ‘enabled’), the differential beam reporting could be enabled/applied for only the first group(s) of resource indicators for simultaneous reception in a/the reporting instance/CSI report, and/or when/if the UE is higher layer configured/provided/indicated by the network, e.g., via/in CSI-ResourceConfig or CSI-ReportConfig, a higher layer parameter—e.g., denoted by DiffReportingSimTX (e.g., set to ‘enabled’), the differential beam reporting could be enabled/applied for the second group(s) of resource indicators for simultaneous transmission in a/the reporting instance/CSI report.
In another example, the UE could autonomously decide or determine whether the differential beam reporting could be applied for either the first group(s) of resource indicators for simultaneous reception according to those specified herein in the present disclosure or the second group(s) of resource indicators for simultaneous transmission according to those specified herein in the present disclosure, or applied for both of the first and second groups of resource indicators in a/the reporting instance/CSI report. For instance, the UE could send to the network, e.g., in part of a/the CSI/beam report, one or more indicators to indicate to the network whether the differential beam reporting is enabled/applied for the first group(s) of resource indicators for simultaneous reception in the beam/CSI report and/or for the second group(s) of resource indicators for simultaneous transmission in the beam/CSI report.
   For example, the UE could send to the network, e.g., in part of a/the beam/CSI report, an (one-bit) indicator to indicate to the network whether the differential beam reporting is enabled/applied for the mixed groups of resource indicators for simultaneous transmission and reception. For instance, when/if the (one-bit) indicator in the beam/CSI report is set to ‘1’ (or ‘0’), the differential beam reporting could be enabled/applied for both of the first and second groups of resource indicators, wherein as specified herein in the present disclosure, the first group(s) of resource indicators are for simultaneous reception and the second group(s) of resource indicators are for simultaneous transmission; when/if the (one-bit) indicator in the beam/CSI report is set to ‘0’ (‘1’), the differential beam reporting could be enabled/applied for either the first group(s) of resource indicators for simultaneous reception or the second group(s) of resource indicators for simultaneous transmission, or enabled/applied for none of the first or second group(s) of resource indicators for simultaneous reception or transmission.
   For another example, the UE could send to the network, e.g., in part of a/the beam/CSI report, an (two-bit) indicator to indicate to the network that whether the differential beam reporting is applied/enabled for the first and/or second group(s) of resource indicators. For instance, when/if the (two-bit) indicator in the CSI/beam report is set to ‘00’ (‘01’, ‘10’ or ‘11’), the differential beam reporting could be enabled/applied for only the first group(s) of resource indicators for simultaneous reception in a/the reporting instance/CSI report. When/if the (two-bit) indicator in the beam/CSI report is set to ‘01’ (‘00’, ‘10’ or ‘11’), the differential beam reporting could be enabled/applied for only the second group(s) of resource indicators for simultaneous transmission in a/the reporting instance/CSI report. When/if the (two-bit) indicator in the beam/CSI report is set to ‘10’ (‘00’, ‘01’ or ‘11’), the differential beam reporting could be enabled/applied for both the first and second groups of resource indicators in a/the reporting instance/CSI report. When/if the (two-bit) indicator in the beam/CSI report is set to ‘11’ (‘00’, ‘01’, ‘10’ or ‘11’), the differential beam reporting may not be enabled/applied to either the first group(s) or the second group(s) of resource indicators in a/the reporting instance/CSI report.

In one example, when/if a/the beam/CSI report contains/includes/comprises one or more first groups of resource indicators (and therefore, their corresponding beam metrics such as L1-RSRPs/L1-SINRs) for simultaneous reception as specified herein in the present disclosure and/or one or more second groups of resource indicators (and therefore, their corresponding beam metrics such as L1-RSRPs/L1-SINRs) for simultaneous transmission as specified herein in the present disclosure, and/or when/if the differential beam reporting is enabled/applied only for the first group(s) of resource indicators for simultaneous reception in a/the reporting instance/CSI report according to those specified herein in the present disclosure—e.g., when/if the higher layer parameter groupBasedBeamReporting-r17 is configured/provided, and/or when/if the number of first group(s) of resource indicators for simultaneous reception to be reported (that can be reported) in a/the reporting instance/CSI report Ng is configured to be larger than one (or equivalently, when/if the corresponding higher layer parameter nrofReportedRSforSimRX representing/denoting the number of first group(s) of resource indicators for simultaneous reception to be reported (that can be reported) in a/the reporting instance/CSI report is configured to be larger than one):
The corresponding beam/CSI report could include/contain/comprise/indicate a/the CSI resource set indicator indicating a/the CSI resource set associated with the largest/highest measured value of L1-RSRP corresponding to a SSBRI or a CRI in a first group of SSBRI(s)/CRI(s) for simultaneous reception as specified herein in the present disclosure among the first group(s) of resource indicators for simultaneous reception in the beam/CSI report, and for each reported first group of resource indicators for simultaneous reception in the reporting instance/CSI report, CRI or SSBRI of the indicated CSI resource set is present first. For instance, a/the CSI resource set indicator could be a one-bit indicator with value of ‘0’ or ‘1’, which indicates the 1^{st} or the 2^{nd} CSI resource set respectively, from which CRI or SSBRI #1 of the 1^{st} resource group among the first group(s) of resource indicators for simultaneous reception in the beam/CSI report is reported from. Remaining resource groups among the first group(s) of resource indicators for simultaneous reception in the beam/CSI report, if reported, follow the same mapping order as the 1^{st} resource group among the first group(s) of resource indicators for simultaneous reception in the beam/CSI report, where CRI or SSBRI #1 of remaining resource groups among the first group(s) of resource indicators for simultaneous reception is reported from the indicated CSI resource set (i.e., the CSI resource set indicated by the CSI resource set indicator in the CSI/beam report). For reported first group(s) of resource indicators for simultaneous reception in the reporting instance/CSI report, CRI or SSBRI #1 and CRI or SSBRI #2 are reported from different CSI resource sets.
The largest measured value of L1-RSRP that corresponds to a SSBRI or a CRI in a first group of SSBRI(s)/CRI(s) for simultaneous reception as specified herein in the present disclosure among the first group(s) of resource indicators for simultaneous reception in the beam/CSI report, e.g., CRI or SSBRI #1 of the 1^{st} resource group among the first group(s) of resource indicators for simultaneous reception in the beam/CSI report, could be quantized to a 7-bit value in the range of [−140,−44] dBm with 1 dB step size. One or more differential L1-RSRP values each corresponding to a SSBRI or a CRI in a first group of SSBRI(s)/CRI(s) for simultaneous reception that is different from the SSBRI or CRI in a first group of resource indicators for simultaneous reception corresponding to the largest measured value of L1-RSRP, e.g., a CRI or a SSBRI of a first group of resource indicators for simultaneous reception that is not the CRI or SSBRI #1 of the 1^{st} resource group among the first group(s) of resource indicators for simultaneous reception in the beam/CSI report, could be quantized to a 4-bit value with 2 dB step size with a reference to the largest measured L1-RSRP value that corresponds to a SSBRI or a CRI of a first group of SSBRI(s)/CRI(s) for simultaneous reception among the first group(s) of resource indicators for simultaneous reception in the beam/CSI report.
For each reported second group of resource indicators for simultaneous transmission in the beam/CSI report, the first CRI or SSBRI in the resource group (i.e., CRI or SSBRI #1) is reported from the 1^{st} (or 2^{nd}) CSI resource set. The second CRI or SSBRI in the resource group (i.e., CRI or SSBRI #2) is reported from the 2^{nd} (or 1^{st}) CSI resource set. For reported second group(s) of resource indicators for simultaneous transmission in the reporting instance/CSI report, CRI or SSBRI #1 and CRI or SSBRI #2 are reported from different CSI resource sets. One or more L1-RSRP values each corresponding to a SSBRI or a CRI of a second group of SSBRI(s)/CRI(s) for simultaneous transmission is quantized to a 7-bit value in the range of [−140,−44] dBm with 1 dB step size.

In one example, when/if a/the beam/CSI report contains/includes/comprises one or more first groups of resource indicators (and therefore, their corresponding beam metrics such as L1-RSRPs/L1-SINRs) for simultaneous reception as specified herein in the present disclosure and/or one or more second groups of resource indicators (and therefore, their corresponding beam metrics such as L1-RSRPs/L1-SINRs) for simultaneous transmission as specified herein in the present disclosure, and/or when/if the differential beam reporting is enabled/applied only for the second group(s) of resource indicators for simultaneous transmission in a/the reporting instance/CSI report according to those specified herein in the present disclosure—e.g., when/if the higher layer parameter groupBasedBeamReporting-r18 is configured/provided and/or set to ‘ULOnly’, and/or when/if the number of second group(s) of resource indicators for simultaneous transmission to be reported (that can be reported) in a/the reporting instance/CSI report Mg is configured to be larger than one (or equivalently, when/if the corresponding higher layer parameter nrofReportedRSforSimTX representing/denoting the number of second group(s) of resource indicators for simultaneous transmission to be reported (that can be reported) in a/the reporting instance/CSI report is configured to be larger than one):
The corresponding beam/CSI report could include/contain/comprise/indicate a/the CSI resource set indicator indicating a/the CSI resource set associated with the largest/highest measured value of L1-RSRP corresponding to a SSBRI or a CRI in a second group of SSBRI(s)/CRI(s) for simultaneous transmission as specified herein in the present disclosure among the second group(s) of resource indicators for simultaneous transmission in the beam/CSI report, and for each reported second group of resource indicators for simultaneous transmission in the reporting instance/CSI report, CRI or SSBRI of the indicated CSI resource set is present first. For instance, a/the CSI resource set indicator could be a one-bit indicator with value of ‘0’ or ‘1’, which indicates the 1^{st} or the 2^{nd} CSI resource set respectively, from which CRI or SSBRI #1 of the 1^{st} resource group among the second group(s) of resource indicators for simultaneous transmission in the beam/CSI report is reported from. Remaining resource groups among the second group(s) of resource indicators for simultaneous transmission in the beam/CSI report, if reported, follow the same mapping order as the 1^{st} resource group among the second group(s) of resource indicators for simultaneous transmission in the beam/CSI report, where CRI or SSBRI #1 of remaining resource groups among the second group(s) of resource indicators for simultaneous transmission is reported from the indicated CSI resource set (i.e., the CSI resource set indicated by the CSI resource set indicator in the CSI/beam report). For reported second group(s) of resource indicators for simultaneous transmission in the reporting instance/CSI report, CRI or SSBRI #1 and CRI or SSBRI #2 are reported from different CSI resource sets.
The largest measured value of L1-RSRP that corresponds to a SSBRI or a CRI in a second group of SSBRI(s)/CRI(s) for simultaneous transmission as specified herein in the present disclosure among the second group(s) of resource indicators for simultaneous transmission in the beam/CSI report, e.g., CRI or SSBRI #1 of the 1^{st} resource group among the second group(s) of resource indicators for simultaneous transmission in the beam/CSI report, could be quantized to a 7-bit value in the range of [−140,−44] dBm with 1 dB step size. One or more differential L1-RSRP values each corresponding to a SSBRI or a CRI in a second group of SSBRI(s)/CRI(s) for simultaneous transmission that is different from the SSBRI or CRI in a second group of resource indicators for simultaneous transmission corresponding to the largest measured value of L1-RSRP, e.g., a CRI or a SSBRI of a second group of resource indicators for simultaneous transmission that is not the CRI or SSBRI #1 of the 1^{st} resource group among the second group(s) of resource indicators for simultaneous transmission in the beam/CSI report, could be quantized to a 4-bit value with 2 dB step size with a reference to the largest measured L1-RSRP value that corresponds to a SSBRI or a CRI of a second group of SSBRI(s)/CRI(s) for simultaneous transmission among the second group(s) of resource indicators for simultaneous transmission in the beam/CSI report.
For each reported first group of resource indicators for simultaneous reception in the beam/CSI report, the first CRI or SSBRI in the resource group (i.e., CRI or SSBRI #1) is reported from the 1^{st} (or 2^{nd}) CSI resource set, and the second CRI or SSBRI in the resource group (i.e., CRI or SSBRI #2) is reported from the 2^{nd} (or 1^{st}) CSI resource set. For reported first group(s) of resource indicators for simultaneous reception in the reporting instance/CSI report, CRI or SSBRI #1 and CRI or SSBRI #2 are reported from different CSI resource sets. One or more L1-RSRP values each corresponding to a SSBRI or a CRI of a first group of SSBRI(s)/CRI(s) for simultaneous reception is quantized to a 7-bit value in the range of [−140,−44] dBm with 1 dB step size.

In one example, when/if a/the beam/CSI report contains/includes/comprises one or more first groups of resource indicators (and therefore, their corresponding beam metrics such as L1-RSRPs/L1-SINRs) for simultaneous reception as specified herein in the present disclosure and/or one or more second groups of resource indicators (and therefore, their corresponding beam metrics such as L1-RSRPs/L1-SINRs) for simultaneous transmission as specified herein in the present disclosure, and/or when/if the differential beam reporting is enabled/applied for both of the first group(s) of resource indicators for simultaneous reception and the second group(s) of resource indicators for simultaneous transmission in a/the reporting instance/CSI report according to those specified herein in the present disclosure—e.g., when/if the higher layer parameter groupBasedBeamReporting-r17 is configured/provided and/or the higher layer parameter groupBasedBeamReporting-r18 is configured/provided and/or set to ‘ULOnly’, and/or when/if the higher layer parameter groupBasedBeamReporting-r18 is configured/provided and/or set to ‘JointULandDL’, and/or when/if the number of first group(s) of resource indicators for simultaneous reception to be reported (that can be reported) in a/the reporting instance/CSI report Ng is configured to be larger than one (or equivalently, when/if the corresponding higher layer parameter nrofReportedRSforSimRX representing/denoting the number of first group(s) of resource indicators for simultaneous reception to be reported (that can be reported) in a/the reporting instance/CSI report is configured to be larger than one), and/or when/if the number of second group(s) of resource indicators for simultaneous transmission to be reported (that can be reported) in a/the reporting instance/CSI report Mg is configured to be larger than one (or equivalently, when/if the corresponding higher layer parameter nrofReportedRSforSimTX representing/denoting the number of second group(s) of resource indicators for simultaneous transmission to be reported (that can be reported) in a/the reporting instance/CSI report is configured to be larger than one), and/or when/if the total number of first group(s) of resource indicators for simultaneous reception and second group(s) of resource indicators for simultaneous transmission to be reported (that can be reported) in a/the reporting instance/CSI report Kg is configured to be larger than one (or equivalently, when/if the corresponding higher layer parameter nrofReportedRSforSimTRX representing/denoting the total number of first group(s) of resource indicators for simultaneous reception and second group(s) of resource indicators for simultaneous transmission to be reported (that can be reported) in a/the reporting instance/CSI report is configured to be larger than one):
The corresponding beam/CSI report could include/contain/comprise/indicate a/the CSI resource set indicator indicating a/the CSI resource set associated with the largest/highest measured value of L1-RSRP among the first group(s) and/or second group(s) of resource indicators in the beam/CSI report. For each reported first group of resource indicators for simultaneous reception in the reporting instance/CSI report, CRI or SSBRI of the indicated CSI resource set is present first. For each reported second group of resource indicators for simultaneous transmission in the reporting instance/CSI report, CRI or SSBRI of the indicated CSI resource set is present first. For instance, a/the CSI resource set indicator could be a one-bit indicator with value of ‘0’ or ‘1’, which indicates the 1^{st} or the 2^{nd} CSI resource set respectively, from which CRI or SSBRI #1 of the 1^{st} resource group among the first group(s) of resource indicators for simultaneous reception in the beam/CSI report is reported from, and from which CRI or SSBRI #1 of the 1^{st} resource group among the second group(s) of resource indicators for simultaneous transmission in the beam/CSI report is reported from. Remaining first and second groups of resource indicators in the beam/CSI report, if reported, follow the same mapping order as the 1^{st} resource group among the first group(s) of resource indicators for simultaneous reception in the beam/CSI report and/or the 1^{st} resource group among the second group(s) of resource indicators for simultaneous transmission in the beam/CSI report, where CRI or SSBRI #1 of remaining resource groups among the first and second groups of resource indicators in the beam/CSI report is reported from the indicated CSI resource set (i.e., the CSI resource set indicated by the CSI resource set indicator in the CSI/beam report). For reported first and second groups of resource indicators in the reporting instance/CSI report, CRI or SSBRI #1 and CRI or SSBRI #2 are reported from different CSI resource sets.
The corresponding beam/CSI report could include/contain/comprise/indicate an (one-bit) indicator indicating to the network whether the largest measured value of L1-RSRP is associated with a first group of resource indicators for simultaneous reception in the corresponding beam/CSI report or associated with a second group of resource indicators for simultaneous transmission in the corresponding beam/CSI report. For instance, when/if the (one-bit) indicator is set to ‘0’ (or ‘1’), the largest measured value of L1-RSRP could be associated with a first group of resource indicators for simultaneous reception, while when/if the (one-bit) indicator is set to ‘1’ (or ‘0’), the largest measured value of L1-RSRP could be associated with a second group of resource indicators for simultaneous transmission, in the corresponding beam/CSI report.
The largest measured value of L1-RSRP among the first group(s) and/or second group(s) of resource indicators in the beam/CSI report, e.g., the L1-RSRP associated with CRI or SSBRI #1 of the 1^{st} resource group among the first group(s) of resource indicators for simultaneous reception in the beam/CSI report and/or the L1-RSRP associated with CRI or SSBRI #1 of the 1^{st} resource group among the second group(s) of resource indicators for simultaneous transmission in the beam/CSI report, could be quantized to a 7-bit value in the range of [−140,−44] dBm with 1 dB step size. Differential L1-RSRP value(s) for the remaining resource indicators of the first and second groups in the beam/CSI report could be quantized to a 4-bit value with 2 dB step size with a reference to the largest measured L1-RSRP value among the first and second groups of resource indicators in the beam/CSI report.

For this case, the position(s)/ordering(s) of the first group(s) of resource indicators for simultaneous reception (and therefore, their corresponding beam metrics such as L1-RSRPs/L1-SINRs) and the second group(s) of resource indicators for simultaneous transmission (and therefore, their corresponding beam metrics such as L1-RSRPs/L1-SINRs) in a/the reporting instance/CSI report could follow those specified herein in the present disclosure (e.g., according to fixed rule(s), network's configuration(s)/indication(s) or UE's determination/selection). Optionally, (1) when/if the largest measured value of L1-RSRP is associated with a first group of resource indicators for simultaneous reception in the beam/CSI report, the first group(s) of resource indicators (and therefore, their corresponding beam metrics such as L1-RSRPs/L1-SINRs) could be present first in the beam/CSI report followed by the second group(s) of resource indicators (and therefore, their corresponding beam metrics such as L1-RSRPs/L1-SINRs), wherein their positions/orderings in the beam/CSI report could still follow one or more of those specified herein in the present disclosure (e.g., according to fixed rule(s), network's configuration(s)/indication(s) or UE's determination/selection), and/or (2) when/if the largest measured value of L1-RSRP is associated with a second group of resource indicators for simultaneous transmission in the beam/CSI report, of the second group(s) of resource indicators (and therefore, their corresponding beam metrics such as L1-RSRPs/L1-SINRs) could be present first in the beam/CSI report, followed by of the first group(s) of resource indicators (and therefore, their corresponding beam metrics such as L1-RSRPs/L1-SINRs), wherein their positions/orderings in the beam/CSI report could still follow one or more of those specified herein in the present disclosure (e.g., according to fixed rule(s), network's configuration(s)/indication(s) or UE's determination/selection). Alternatively, (1) when/if the largest measured value of L1-RSRP is associated with a first group of resource indicators for simultaneous reception in the beam/CSI report, the first group of resource indicators for simultaneous reception that is associated to the largest measured value of L1-RSRP could be present first in the beam/CSI report, followed by the remaining first group(s) of resource indicators for simultaneous reception and of the second group(s) of resource indicators for simultaneous transmission in the beam/CSI report whose positions/orderings in the beam/CSI report could follow one or more of those specified herein in the present disclosure (e.g., according to fixed rule(s), network's configuration(s)/indication(s) or UE's determination/selection), and/or (2) when/if the largest measured value of L1-RSRP is associated with a second group of resource indicators for simultaneous transmission in the beam/CSI report, the second group of resource indicators for simultaneous transmission that is associated to the largest measured value of L1-RSRP could be present first in the beam/CSI report, followed by the remaining second group(s) of resource indicators for simultaneous transmission and of the first group(s) of resource indicators for simultaneous reception in the beam/CSI report whose positions/orderings in the beam/CSI report could follow one or more of those specified herein in the present disclosure (e.g., according to fixed rule(s), network's configuration(s)/indication(s) or UE's determination/selection).

In one example, when/if a/the beam/CSI report contains/includes/comprises one or more first groups of resource indicators (and therefore, their corresponding beam metrics such as L1-RSRPs/L1-SINRs) for simultaneous reception as specified herein in the present disclosure and/or one or more second groups of resource indicators (and therefore, their corresponding beam metrics such as L1-RSRPs/L1-SINRs) for simultaneous transmission as specified herein in the present disclosure, and/or when/if the differential beam reporting is enabled/applied for both of the first group(s) of resource indicators for simultaneous reception and the second group(s) of resource indicators for simultaneous transmission in a/the reporting instance/CSI report according to those specified herein in the present disclosure—e.g., when/if the higher layer parameter groupBasedBeamReporting-r17 is configured/provided and/or the higher layer parameter groupBasedBeamReporting-r18 is configured/provided and/or set to ‘ULOnly’, and/or when/if the higher layer parameter groupBasedBeamReporting-r18 is configured/provided and/or set to ‘JointULandDL’, and/or when/if the number of first group(s) of resource indicators for simultaneous reception to be reported (that can be reported) in a/the reporting instance/CSI report Ng is configured to be larger than one (or equivalently, when/if the corresponding higher layer parameter nrofReportedRSforSimRX representing/denoting the number of first group(s) of resource indicators for simultaneous reception to be reported (that can be reported) in a/the reporting instance/CSI report is configured to be larger than one), and/or when/if the number of second group(s) of resource indicators for simultaneous transmission to be reported (that can be reported) in a/the reporting instance/CSI report Mg is configured to be larger than one (or equivalently, when/if the corresponding higher layer parameter nrofReportedRSforSimTX representing/denoting the number of second group(s) of resource indicators for simultaneous transmission to be reported (that can be reported) in a/the reporting instance/CSI report is configured to be larger than one), and/or when/if the total number of first group(s) of resource indicators for simultaneous reception and second group(s) of resource indicators for simultaneous transmission to be reported (that can be reported) in a/the reporting instance/CSI report Kg is configured to be larger than one (or equivalently, when/if the corresponding higher layer parameter nrofReportedRSforSimTRX representing/denoting the total number of first group(s) of resource indicators for simultaneous reception and second group(s) of resource indicators for simultaneous transmission to be reported (that can be reported) in a/the reporting instance/CSI report is configured to be larger than one):
The corresponding beam/CSI report could include/contain/comprise/indicate two CSI resource set indicators—denoted by a first CSI resource indicator and a second CSI resource set indicator, wherein the first CSI resource set indicator could indicate a first CSI resource set associated with a first largest/highest measured value of L1-RSRP corresponding to a SSBRI or a CRI in a first group of SSBRI(s)/CRI(s) for simultaneous reception as specified herein in the present disclosure among the first group(s) of resource indicators for simultaneous reception in the beam/CSI report, and the second CSI resource set indicator could indicate a second CSI resource set associated with a second largest/highest measured value of L1-RSRP corresponding to a SSBRI or a CRI in a second group of SSBRI(s)/CRI(s) for simultaneous transmission as specified herein in the present disclosure among the second group(s) of resource indicators for simultaneous transmission in the beam/CSI report. For example:
   The first CSI resource set indicator could be a one-bit indicator with value of ‘0’ or ‘1’, which indicates the 1^{st} or the 2^{nd} CSI resource set respectively, from which CRI or SSBRI #1 of the 1^{st} resource group among the first group(s) of resource indicators for simultaneous reception in the beam/CSI report is reported from. Remaining resource groups among the first group(s) of resource indicators for simultaneous reception in the beam/CSI report, if reported, follow the same mapping order as the 1^{st} resource group among the first group(s) of resource indicators for simultaneous reception in the beam/CSI report, where CRI or SSBRI #1 of remaining resource groups among the first group(s) of resource indicators for simultaneous reception is reported from the indicated first CSI resource set (i.e., the first CSI resource set indicated by the first CSI resource set indicator in the CSI/beam report). For reported first group(s) of resource indicators for simultaneous reception in the reporting instance/CSI report, CRI or SSBRI #1 and CRI or SSBRI #2 are reported from different CSI resource sets.
   The second CSI resource set indicator could be a one-bit indicator with value of ‘0’ or ‘1’, which indicates the 1^{st} or the 2^{nd} CSI resource set respectively, from which CRI or SSBRI #1 of the 1^{st} resource group among the second group(s) of resource indicators for simultaneous transmission in the beam/CSI report is reported from; remaining resource groups among the second group(s) of resource indicators for simultaneous transmission in the beam/CSI report, if reported, follow the same mapping order as the 1^{st} resource group among the second group(s) of resource indicators for simultaneous transmission in the beam/CSI report, where CRI or SSBRI #1 of remaining resource groups among the second group(s) of resource indicators for simultaneous transmission is reported from the indicated second CSI resource set (i.e., the second CSI resource set indicated by the second CSI resource set indicator in the CSI/beam report). For reported second group(s) of resource indicators for simultaneous transmission in the reporting instance/CSI report, CRI or SSBRI #1 and CRI or SSBRI #2 are reported from different CSI resource sets.
The first largest measured value of L1-RSRP that corresponds to a SSBRI or a CRI in a first group of SSBRI(s)/CRI(s) for simultaneous reception as specified herein in the present disclosure among the first group(s) of resource indicators for simultaneous reception in the beam/CSI report, e.g., CRI or SSBRI #1 of the 1^{st} resource group among the first group(s) of resource indicators for simultaneous reception in the beam/CSI report, could be quantized to a 7-bit value in the range of [−140,−44] dBm with 1 dB step size. One or more differential L1-RSRP values each corresponding to a SSBRI or a CRI in a first group of SSBRI(s)/CRI(s) for simultaneous reception that is different from the SSBRI or CRI in a first group of resource indicators for simultaneous reception corresponding to the first largest measured value of L1-RSRP, e.g., a CRI or a SSBRI of a first group of resource indicators for simultaneous reception that is not the CRI or SSBRI #1 of the 1^{st} resource group among the first group(s) of resource indicators for simultaneous reception in the beam/CSI report, could be quantized to a 4-bit value with 2 dB step size with a reference to the first largest measured L1-RSRP value that corresponds to a SSBRI or a CRI of a first group of SSBRI(s)/CRI(s) for simultaneous reception among the first group(s) of resource indicators for simultaneous reception in the beam/CSI report.
The second largest measured value of L1-RSRP that corresponds to a SSBRI or a CRI in a second group of SSBRI(s)/CRI(s) for simultaneous transmission as specified herein in the present disclosure among the second group(s) of resource indicators for simultaneous transmission in the beam/CSI report, e.g., CRI or SSBRI #1 of the 1^{st} resource group among the second group(s) of resource indicators for simultaneous transmission in the beam/CSI report, could be quantized to a 7-bit value in the range of [−140,−44] dBm with 1 dB step size. One or more differential L1-RSRP values each corresponding to a SSBRI or a CRI in a second group of SSBRI(s)/CRI(s) for simultaneous transmission that is different from the SSBRI or CRI in a second group of resource indicators for simultaneous transmission corresponding to the second largest measured value of L1-RSRP, e.g., a CRI or a SSBRI of a second group of resource indicators for simultaneous transmission that is not the CRI or SSBRI #1 of the 1^{st} resource group among the second group(s) of resource indicators for simultaneous transmission in the beam/CSI report, could be quantized to a 4-bit value with 2 dB step size with a reference to the second largest measured L1-RSRP value that corresponds to a SSBRI or a CRI of a second group of SSBRI(s)/CRI(s) for simultaneous transmission among the second group(s) of resource indicators for simultaneous transmission in the beam/CSI report.

In one example, when/if a/the beam/CSI report contains/includes/comprises one or more first groups of resource indicators (and therefore, their corresponding beam metrics such as L1-RSRPs/L1-SINRs) for simultaneous reception as specified herein in the present disclosure and/or one or more second groups of resource indicators (and therefore, their corresponding beam metrics such as L1-RSRPs/L1-SINRs) for simultaneous transmission as specified herein in the present disclosure, and/or when/if the differential beam reporting is enabled/applied for both of the first group(s) of resource indicators for simultaneous reception and the second group(s) of resource indicators for simultaneous transmission in a/the reporting instance/CSI report according to those specified herein in the present disclosure—e.g., when/if the higher layer parameter groupBasedBeamReporting-r17 is configured/provided and/or the higher layer parameter groupBasedBeamReporting-r18 is configured/provided and/or set to ‘ULOnly’, and/or when/if the higher layer parameter groupBasedBeamReporting-r18 is configured/provided and/or set to ‘JointULandDL’, and/or when/if the number of first group(s) of resource indicators for simultaneous reception to be reported (that can be reported) in a/the reporting instance/CSI report Ng is configured to be larger than one (or equivalently, when/if the corresponding higher layer parameter nrofReportedRSforSimRX representing/denoting the number of first group(s) of resource indicators for simultaneous reception to be reported (that can be reported) in a/the reporting instance/CSI report is configured to be larger than one), and/or when/if the number of second group(s) of resource indicators for simultaneous transmission to be reported (that can be reported) in a/the reporting instance/CSI report Mg is configured to be larger than one (or equivalently, when/if the corresponding higher layer parameter nrofReportedRSforSimTX representing/denoting the number of second group(s) of resource indicators for simultaneous transmission to be reported (that can be reported) in a/the reporting instance/CSI report is configured to be larger than one), and/or when/if the total number of first group(s) of resource indicators for simultaneous reception and second group(s) of resource indicators for simultaneous transmission to be reported (that can be reported) in a/the reporting instance/CSI report Kg is configured to be larger than one (or equivalently, when/if the corresponding higher layer parameter nrofReportedRSforSimTRX representing/denoting the total number of first group(s) of resource indicators for simultaneous reception and second group(s) of resource indicators for simultaneous transmission to be reported (that can be reported) in a/the reporting instance/CSI report is configured to be larger than one):
The corresponding beam/CSI report could include/contain/comprise/indicate a/the CSI resource set indicator indicating a/the CSI resource set associated with the largest/highest measured value of L1-RSRP among the first group(s) and/or second group(s) of resource indicators in the beam/CSI report. For each reported first group of resource indicators for simultaneous reception in the reporting instance/CSI report, CRI or SSBRI of the indicated CSI resource set is present first. For each reported second group of resource indicators for simultaneous transmission in the reporting instance/CSI report, CRI or SSBRI of the indicated CSI resource set is present first. For instance, a/the CSI resource set indicator could be a one-bit indicator with value of ‘0’ or ‘1’, which indicates the 1^{st} or the 2^{nd} CSI resource set respectively, from which CRI or SSBRI #1 of the 1^{st} resource group among the first group(s) of resource indicators for simultaneous reception in the beam/CSI report is reported from, and from which CRI or SSBRI #1 of the 1^{st} resource group among the second group(s) of resource indicators for simultaneous transmission in the beam/CSI report is reported from. Remaining first and second groups of resource indicators in the beam/CSI report, if reported, follow the same mapping order as the 1^{st} resource group among the first group(s) of resource indicators for simultaneous reception in the beam/CSI report and/or the 1^{st} resource group among the second group(s) of resource indicators for simultaneous transmission in the beam/CSI report, where CRI or SSBRI #1 of remaining resource groups among the first and second groups of resource indicators in the beam/CSI report is reported from the indicated CSI resource set (i.e., the CSI resource set indicated by the CSI resource set indicator in the CSI/beam report). For reported first and second groups of resource indicators in the reporting instance/CSI report, CRI or SSBRI #1 and CRI or SSBRI #2 are reported from different CSI resource sets.
The corresponding beam/CSI report could include/contain/comprise/indicate an (one-bit) indicator indicating to the network (e.g., the network 130) whether the largest measured value of L1-RSRP is associated with a first group of resource indicators for simultaneous reception in the corresponding beam/CSI report or associated with a second group of resource indicators for simultaneous transmission in the corresponding beam/CSI report. For instance, when/if the (one-bit) indicator is set to ‘0’ (or ‘1’), the largest measured value of L1-RSRP could be associated with a first group of resource indicators for simultaneous reception, while when/if the (one-bit) indicator is set to ‘1’ (or ‘0’), the largest measured value of L1-RSRP could be associated with a second group of resource indicators for simultaneous transmission in the corresponding beam/CSI report.
When/if the largest measured value of L1-RSRP that is used to determine the indicated CSI resource set (i.e., the CSI resource set indicated by the CSI resource set indicator in the CSI/beam report) is associated with a first group of resource indicators for simultaneous reception in the beam/CSI report:
   The largest measured value of L1-RSRP that is used to determine the indicated CSI resource set (i.e., the CSI resource set indicated by the CSI resource set indicator in the CSI/beam report) and associated with a first group of resource indicators for simultaneous reception in the beam/CSI report, e.g., the L1-RSRP associated with CRI or SSBRI #1 of the 1^{st} resource group among the first group(s) of resource indicators for simultaneous reception in the beam/CSI report, could be quantized to a 7-bit value in the range of [−140,−44] dBm with 1 dB step size. Differential L1-RSRP value(s) for the remaining resource indicators of the first group(s) in the beam/CSI report could be quantized to a 4-bit value with 2 dB step size with a reference to the largest measured L1-RSRP value that is used to determine the indicated CSI resource set (i.e., the CSI resource set indicated by the CSI resource set indicator in the CSI/beam report) and associated with a first group of resource indicators for simultaneous reception in the beam/CSI report.
   For reporting the L1-RSRP value(s) associated with the second group(s) of resource indicators for simultaneous transmission in the beam/CSI report:
      In one example, the largest measured value of L1-RSRP among the second group(s) of resource indicators for simultaneous transmission in the beam/CSI report, e.g., the L1-RSRP associated with CRI or SSBRI #1 of the 1^{st} resource group among the second group(s) of resource indicators for simultaneous transmission in the beam/CSI report, could be quantized to a 7-bit value in the range of [−140,−44] dBm with 1 dB step size. Differential L1-RSRP value(s) for the remaining resource indicators of the second group(s) in the beam/CSI report could be quantized to a 4-bit value with 2 dB step size with a reference to the largest measured L1-RSRP value among the second group(s) of resource indicators for simultaneous transmission in the beam/CSI report. For this case, the UE could send to the network, e.g., in part of a/the reporting instance/CSI report, one or more indicators and/or resource group indexes to indicate to the network the position/ordering/identify/index of the second group of resource indicators for simultaneous transmission in the corresponding beam/CSI report that is associated with the largest measured value of L1-RSRP among the reported second group(s) in the beam/CSI report. Optionally, the UE could send to the network, e.g., in part of a/the reporting instance/CSI report, an (one-bit) indicator to indicate to the network which of the two reported resource indicators in the second group of resource indicators that is associated with the largest measured L1-RSRP value among the second group(s) of resource indicators for simultaneous transmission in the beam/CSI report, the largest measured L1-RSRP value among the second group(s) of resource indicators is associated with. For instance, when/if the (one-bit) indicator in the beam/CSI report is set to ‘0’ (or ‘1’), the largest measured L1-RSRP value among the second group(s) of resource indicators for simultaneous transmission in the beam/CSI report could correspond to the L1-RSRP of CRI or SSBRI #1 of the second group of resource indicators that is associated with the largest measured L1-RSRP value among the second group(s) of resource indicators for simultaneous transmission in the beam/CSI report (e.g., the 1^{st} resource group among the second group(s) of resource indicators in the beam/CSI report). When/if the (one-bit) indicator in the beam/CSI report is set to ‘1’ (or ‘0’), the largest measured L1-RSRP value among the second group(s) of resource indicators for simultaneous transmission in the beam/CSI report could correspond to the L1-RSRP of CRI or SSBRI #2 of the second group of resource indicators that is associated with the largest measured L1-RSRP value among the second group(s) of resource indicators for simultaneous transmission in the beam/CSI report (e.g., the 1^{st} resource group among the second group(s) of resource indicators in the beam/CSI report).
      In another example, differential L1-RSRP value(s) for the resource indicators of the second group(s) in the beam/CSI report could be quantized to a x-bit value with dB step size with a reference to the largest measured L1-RSRP value that is used to determine the indicated CSI resource set (i.e., the CSI resource set indicated by the CSI resource set indicator in the CSI/beam report) and associated with a first group of resource indicators for simultaneous reception in the beam/CSI report. For this case, the value(s) of x and/or y as described above/specified herein in the present disclosure could be: (1) determined according to fixed/predefined value(s) in system specification(s), (2) configured/indicated/provided by the network, e.g., via higher layer RRC signaling/parameter and/or MAC CE command and/or dynamic DCI based L1 signaling, and/or (3) autonomously determined by the UE, and reported to the network, e.g., in part of a/the reporting instance/CSI report.
      In yet another example, differential L1-RSRP value(s) for the resource indicators of the second group(s) in the beam/CSI report could be quantized to a 4-bit value with 2 dB step size with a reference to the largest measured L1-RSRP value that is used to determine the indicated CSI resource set (i.e., the CSI resource set indicated by the CSI resource set indicator in the CSI/beam report) and associated with a first group of resource indicators for simultaneous reception in the beam/CSI report plus/minus an offset RSRP value. For this case, the offset RSRP value as described above/specified herein in the present disclosure could be: (1) determined according to fixed/predefined value(s) in system specification(s), (2) configured/indicated/provided by the network, e.g., via higher layer RRC signaling/parameter and/or MAC CE command and/or dynamic DCI based L1 signaling, and/or (3) autonomously determined by the UE, and reported to the network, e.g., in part of a/the reporting instance/CSI report.
When/if the largest measured value of L1-RSRP that is used to determine the indicated CSI resource set (i.e., the CSI resource set indicated by the CSI resource set indicator in the CSI/beam report) is associated with a second group of resource indicators for simultaneous transmission in the beam/CSI report:
   The largest measured value of L1-RSRP that is used to determine the indicated CSI resource set (i.e., the CSI resource set indicated by the CSI resource set indicator in the CSI/beam report) and associated with a second group of resource indicators for simultaneous transmission in the beam/CSI report, e.g., the L1-RSRP associated with CRI or SSBRI #1 of the 1^{st} resource group among the second group(s) of resource indicators for simultaneous transmission in the beam/CSI report, could be quantized to a 7-bit value in the range of [−140,−44] dBm with 1 dB step size. Differential L1-RSRP value(s) for the remaining resource indicators of the second group(s) in the beam/CSI report could be quantized to a 4-bit value with 2 dB step size with a reference to the largest measured L1-RSRP value that is used to determine the indicated CSI resource set (i.e., the CSI resource set indicated by the CSI resource set indicator in the CSI/beam report) and associated with a second group of resource indicators for simultaneous transmission in the beam/CSI report.
   For reporting the L1-RSRP value(s) associated with the first group(s) of resource indicators for simultaneous reception in the beam/CSI report:
      In one example, the largest measured value of L1-RSRP among the first group(s) of resource indicators for simultaneous reception in the beam/CSI report, e.g., the L1-RSRP associated with CRI or SSBRI #1 of the 1^{st} resource group among the first group(s) of resource indicators for simultaneous reception in the beam/CSI report, could be quantized to a 7-bit value in the range of [−140,−44] dBm with 1 dB step size. Differential L1-RSRP value(s) for the remaining resource indicators of the first group(s) in the beam/CSI report could be quantized to a 4-bit value with 2 dB step size with a reference to the largest measured L1-RSRP value among the first group(s) of resource indicators for simultaneous reception in the beam/CSI report. For this case, the UE could send to the network, e.g., in part of a/the reporting instance/CSI report, one or more indicators and/or resource group indexes to indicate to the network the position/ordering/identify/index of the first group of resource indicators for simultaneous reception in the corresponding beam/CSI report that is associated with the largest measured value of L1-RSRP among the reported first group(s) in the beam/CSI report. Optionally, the UE could send to the network, e.g., in part of a/the reporting instance/CSI report, an (one-bit) indicator to indicate to the network which of the two reported resource indicators in the first group of resource indicators that is associated with the largest measured L1-RSRP value among the first group(s) of resource indicators for simultaneous reception in the beam/CSI report, the largest measured L1-RSRP value among the first group(s) of resource indicators is associated with. For instance, when/if the (one-bit) indicator in the beam/CSI report is set to ‘0’ (or ‘1’), the largest measured L1-RSRP value among the first group(s) of resource indicators for simultaneous reception in the beam/CSI report could correspond to the L1-RSRP of CRI or SSBRI #1 of the first group of resource indicators that is associated with the largest measured L1-RSRP value among the first group(s) of resource indicators for simultaneous reception in the beam/CSI report (e.g., the 1^{st} resource group among the first group(s) in the beam/CSI report). When/if the (one-bit) indicator in the beam/CSI report is set to ‘1’ (or ‘0’), the largest measured L1-RSRP value among the first group(s) of resource indicators for simultaneous reception in the beam/CSI report could correspond to the L1-RSRP of CRI or SSBRI #2 of the first group of resource indicators that is associated with the largest measured L1-RSRP value among the first group(s) of resource indicators for simultaneous reception in the beam/CSI report (e.g., the 1^{st} resource group among the first group(s) in the beam/CSI report).
      In another example, differential L1-RSRP value(s) for the resource indicators of the first group(s) in the beam/CSI report could be quantized to a x-bit value with dB step size with a reference to the largest measured L1-RSRP value that is used to determine the indicated CSI resource set (i.e., the CSI resource set indicated by the CSI resource set indicator in the CSI/beam report) and associated with a second group of resource indicators for simultaneous transmission in the beam/CSI report. For this case, the value(s) of x and/or y as described above/specified herein in the present disclosure could be: (1) determined according to fixed/predefined value(s) in system specification(s), (2) configured/indicated/provided by the network, e.g., via higher layer RRC signaling/parameter and/or MAC CE command and/or dynamic DCI based L1 signaling, and/or (3) autonomously determined by the UE, and reported to the network, e.g., in part of a/the reporting instance/CSI report.
      In yet another example, differential L1-RSRP value(s) for the resource indicators of the first group(s) in the beam/CSI report could be quantized to a 4-bit value with 2 dB step size with a reference to the largest measured L1-RSRP value that is used to determine the indicated CSI resource set (i.e., the CSI resource set indicated by the CSI resource set indicator in the CSI/beam report) and associated with a second group of resource indicators for simultaneous transmission in the beam/CSI report plus/minus an offset RSRP value. For this case, the offset RSRP value as described above/specified herein in the present disclosure could be: (1) determined according to fixed/predefined value(s) in system specification(s), (2) configured/indicated/provided by the network, e.g., via higher layer RRC signaling/parameter and/or MAC CE command and/or dynamic DCI based L1 signaling, and/or (3) autonomously determined by the UE, and reported to the network, e.g., in part of a/the reporting instance/CSI report.

For this case, the position(s)/ordering(s) of the first group(s) of resource indicators for simultaneous reception (and therefore, their corresponding beam metrics such as L1-RSRPs/L1-SINRs) and the second group(s) of resource indicators for simultaneous transmission (and therefore, their corresponding beam metrics such as L1-RSRPs/L1-SINRs) in a/the reporting instance/CSI report could follow those specified herein in the present disclosure (e.g., according to fixed rule(s), network's configuration(s)/indication(s) or UE's determination/selection). Optionally, (1) when/if the largest measured value of L1-RSRP that is used to determine the indicated CSI resource set (i.e., the CSI resource set indicated by the CSI resource set indicator in the CSI/beam report) is associated with a first group of resource indicators for simultaneous reception in the beam/CSI report, the first group(s) of resource indicators (and therefore, their corresponding beam metrics such as L1-RSRPs/L1-SINRs) could be present first in the beam/CSI report, followed by the second group(s) of resource indicators (and therefore, their corresponding beam metrics such as L1-RSRPs/L1-SINRs), wherein their positions/orderings in the beam/CSI report could still follow one or more of those specified herein in the present disclosure (e.g., according to fixed rule(s), network's configuration(s)/indication(s) or UE's determination/selection), and/or (2) when/if the largest measured value of L1-RSRP that is used to determine the indicated CSI resource set (i.e., the CSI resource set indicated by the CSI resource set indicator in the CSI/beam report) is associated with a second group of resource indicators for simultaneous transmission in the beam/CSI report, the second group(s) of resource indicators (and therefore, their corresponding beam metrics such as L1-RSRPs/L1-SINRs) could be present first in the beam/CSI report, followed by the first group(s) of resource indicators (and therefore, their corresponding beam metrics such as L1-RSRPs/L1-SINRs), wherein their positions/orderings in the beam/CSI report could still follow one or more of those specified herein in the present disclosure (e.g., according to fixed rule(s), network's configuration(s)/indication(s) or UE's determination/selection). Alternatively, (1) when/if the largest measured value of L1-RSRP that is used to determine the indicated CSI resource set (i.e., the CSI resource set indicated by the CSI resource set indicator in the CSI/beam report) is associated with a first group of resource indicators for simultaneous reception in the beam/CSI report, the first group of resource indicators for simultaneous reception that is associated to the largest measured value of L1-RSRP could be present first in the beam/CSI report, followed by the remaining first group(s) of resource indicators for simultaneous reception and the second group(s) of resource indicators for simultaneous transmission in the beam/CSI report whose positions/orderings in the beam/CSI report could follow one or more of those specified herein in the present disclosure (e.g., according to fixed rule(s), network's configuration(s)/indication(s) or UE's determination/selection), and/or (2) when/if the largest measured value of L1-RSRP that is used to determine the indicated CSI resource set (i.e., the CSI resource set indicated by the CSI resource set indicator in the CSI/beam report) is associated with a second group of resource indicators for simultaneous transmission in the beam/CSI report, the second group of resource indicators for simultaneous transmission that is associated to the largest measured value of L1-RSRP could be present first in the beam/CSI report, followed by the remaining second group(s) of resource indicators for simultaneous transmission and the first group(s) of resource indicators for simultaneous reception in the beam/CSI report whose positions/orderings in the beam/CSI report could follow one or more of those specified herein in the present disclosure (e.g., according to fixed rule(s), network's configuration(s)/indication(s) or UE's determination/selection).

In one example, when/if a/the beam/CSI report contains/includes/comprises one or more groups of resource indicators such as CRIs and/or SSBRIs (and therefore, their corresponding beam metrics such as L1-RSRPs/L1-SINRs) for both simultaneous transmission and reception such that the RS resources including CSI-RS and/or SSB resources of each group can be received simultaneously and applied for simultaneous transmission with spatial filters by a UE (e.g., the 116)—e.g., when/if the higher layer parameter groupBasedBeamReporting-r18 is configured/provided and/or set to ‘JointULandDL’:
In one example (example-I), the UE could report, in a/the beam/CSI report or reporting instance, a group of beam metrics for both simultaneous s reception and transmission corresponding/associated to a group of resource indicators for both simultaneous reception and transmission. For this design example, the UE could obtain, determine or identify the group of beam metrics (including L1-RSRPs and/or L1-SINRs) for both simultaneous reception and transmission based on or according to simultaneous reception and transmission of the RS resources including CSI-RS and/or SSB resources of the group of resource indicators for both simultaneous reception and transmission. When/if differential beam reporting is enabled, e.g., when/if the higher layer parameter groupBasedBeamReporting-r18 is configured/provided and/or set to ‘JointULandDL’, and/or the number (e.g., configured/provided by the network via the corresponding higher layer parameter(s)) of the one or more groups of resource indicators is larger than one, and/or the number (e.g., configured/provided by the network via the corresponding higher layer parameter(s)) of the one or more groups of beam metrics is larger than one, the UE could indicate, in a/the beam/CSI report or reporting instance, the CSI resource set (e.g., in form of a CSI resource set indicator) associate with the largest (measured, calculated, computed, averaged, etc.) value of beam metric (e.g., L1-RSRP) obtained, determined or identified for both simultaneous reception and transmission according to or following those specified herein in the present disclosure, and for each group of resource indicators, CRI or SSBRI of the indicated CSI resource set is present first. In this case, the CSI resource set indicator could be a one-bit indicator with ‘0’ (or ‘1’) indicating a/the 1st CSI resource set and ‘1’ (or ‘0’) indicating a/the 2nd CSI resource set configured/provided/enabled for the group based beam reporting. For the differential L1-RSRP based reporting, the largest (measured, calculated, computed, averaged, etc.) value of L1-RSRP obtained, determined or identified for both simultaneous reception and transmission according to or following those specified herein in the present disclosure could be quantized to a 7-bit value in the range of [−140,−44] dBm with 1 dB step size, and a differential L1-RSRP value obtained, determined or identified for both simultaneous reception and transmission according to or following those specified herein in the present disclosure could be quantized to a 4-bit value with 2 dB step size with a reference to the largest (measured, calculated, computed, averaged, etc.) value of L1-RSRP obtained, determined or identified for both simultaneous reception and transmission according to or following those specified herein in the present disclosure which is part of the same L1-RSRP reporting instance.
In another example (example-II), the UE could report, in a/the beam/CSI report or reporting instance, a group of beam metrics for simultaneous reception corresponding/associated to a group of resource indicators for both simultaneous reception and transmission. For this design example, the UE could obtain, determine or identify the group of beam metrics (including L1-RSRPs and/or L1-SINRs) for simultaneous reception based on or according to only simultaneous reception of the RS resources including CSI-RS and/or SSB resources of the group of resource indicators for both simultaneous reception and transmission. When/if differential beam reporting is enabled, e.g., when/if the higher layer parameter groupBasedBeamReporting-r18 is configured/provided and/or set to ‘JointULandDL’, and/or the number (e.g., configured/provided by the network via the corresponding higher layer parameter(s)) of the one or more groups of resource indicators is larger than one, and/or the number (e.g., configured/provided by the network via the corresponding higher layer parameter(s)) of the one or more groups of beam metrics is larger than one, the UE could indicate, in a/the beam/CSI report or reporting instance, the CSI resource set (e.g., in form of a CSI resource set indicator) associate with the largest (measured, calculated, computed, averaged, etc.) value of beam metric (e.g., L1-RSRP) obtained, determined or identified for simultaneous reception according to or following those specified herein in the present disclosure, and for each group of resource indicators, CRI or SSBRI of the indicated CSI resource set is present first. In this case, the CSI resource set indicator could be a one-bit indicator with ‘0’ (or ‘1’) indicating a/the 1st CSI resource set and ‘1’ (or ‘0’) indicating a/the 2nd CSI resource set configured/provided/enabled for the group based beam reporting. For the differential L1-RSRP based reporting, the largest (measured, calculated, computed, averaged, etc.) value of L1-RSRP obtained, determined or identified for simultaneous reception according to or following those specified herein in the present disclosure could be quantized to a 7-bit value in the range of [−140,−44] dBm with 1 dB step size, and a differential L1-RSRP value obtained, determined or identified for simultaneous reception according to or following those specified herein in the present disclosure could be quantized to a 4-bit value with 2 dB step size with a reference to the largest (measured, calculated, computed, averaged, etc.) value of L1-RSRP obtained, determined or identified for simultaneous reception according to or following those specified herein in the present disclosure which is part of the same L1-RSRP reporting instance.
In another example (example-III), the UE could report, in a/the beam/CSI report or reporting instance, a group of beam metrics for simultaneous transmission corresponding/associated to a group of resource indicators for both simultaneous reception and transmission. For this design example, the UE could obtain, determine, or identify the group of beam metrics (including L1-RSRPs and/or L1-SINRs) for simultaneous transmission based on or according to only simultaneous transmission of the RS resources including CSI-RS and/or SSB resources of the group of resource indicators for both simultaneous reception and transmission. When/if differential beam reporting is enabled, e.g., when/if the higher layer parameter groupBasedBeamReporting-r18 is configured/provided and/or set to ‘JointULandDL’, and/or the number (e.g., configured/provided by the network via the corresponding higher layer parameter(s)) of the one or more groups of resource indicators is larger than one, and/or the number (e.g., configured/provided by the network via the corresponding higher layer parameter(s)) of the one or more groups of beam metrics is larger than one, the UE could indicate, in a/the beam/CSI report or reporting instance, the CSI resource set (e.g., in form of a CSI resource set indicator) associate with the largest (measured, calculated, computed, averaged, etc.) value of beam metric (e.g., L1-RSRP) obtained, determined or identified for simultaneous transmission according to or following those specified herein in the present disclosure, and for each group of resource indicators, CRI or SSBRI of the indicated CSI resource set is present first. In this case, the CSI resource set indicator could be a one-bit indicator with ‘0’ (or ‘1’) indicating a/the 1st CSI resource set and ‘1’ (or ‘0’) indicating a/the 2nd CSI resource set configured/provided/enabled for the group based beam reporting. For the differential L1-RSRP based reporting, the largest (measured, calculated, computed, averaged, etc.) value of L1-RSRP obtained, determined or identified for simultaneous transmission according to or following those specified herein in the present disclosure could be quantized to a 7-bit value in the range of [−140,−44] dBm with 1 dB step size, and a differential L1-RSRP value obtained, determined or identified for simultaneous transmission according to or following those specified herein in the present disclosure could be quantized to a 4-bit value with 2 dB step size with a reference to the largest (measured, calculated, computed, averaged, etc.) value of L1-RSRP obtained, determined or identified for simultaneous transmission according to or following those specified herein in the present disclosure which is part of the same L1-RSRP reporting instance.
In another example (example-IV), the UE could report, in a/the beam/CSI report or reporting instance, a first group of beam metrics for both simultaneous reception and transmission, a second group of beam metrics for simultaneous reception and a third group of beam metrics for simultaneous transmission corresponding/associated to a group of resource indicators for both simultaneous reception and transmission. For this design example, the UE could obtain, determine or identify the first group of beam metrics (including L1-RSRPs and/or L1-SINRs) for simultaneous reception and transmission based on or according to simultaneous reception and transmission of the RS resources including CSI-RS and/or SSB resources of the group of resource indicators for both simultaneous reception and transmission; in addition, the UE could obtain, determine or identify the second group of beam metrics (including L1-RSRPs and/or L1-SINRs) for simultaneous reception based on or according to only simultaneous reception of the RS resources including CSI-RS and/or SSB resources of the group of resource indicators for both simultaneous reception and transmission; furthermore, the UE could obtain, determine or identify the third group of beam metrics (including L1-RSRPs and/or L1-SINRs) for simultaneous transmission based on or according to only simultaneous transmission of the RS resources including CSI-RS and/or SSB resources of the group of resource indicators for both simultaneous reception and transmission.
   When/if differential beam reporting is enabled, e.g., for both simultaneous reception and transmission, e.g., when/if the higher layer parameter groupBasedBeamReporting-r18 is configured/provided and/or set to ‘JointULandDL’, and/or the number (e.g., configured/provided by the network via the corresponding higher layer parameter(s)) of the one or more groups of resource indicators is larger than one, and/or the number (e.g., configured/provided by the network via the corresponding higher layer parameter(s)) of one or more groups of beam metrics for both simultaneous reception and transmission is larger than one, the UE could indicate, in a/the beam/CSI report or reporting instance, a first CSI resource set (e.g., in form of a first CSI resource set indicator) associate with the largest (measured, calculated, computed, averaged, etc.) value of beam metric (e.g., L1-RSRP) obtained, determined or identified for both simultaneous reception and transmission according to or following those specified herein in the present disclosure. In this case, the first CSI resource set indicator could be a one-bit indicator with ‘0’ (or ‘1’) indicating a/the 1st CSI resource set and ‘1’ (or ‘0’) indicating a/the 2nd CSI resource set configured/provided/enabled for the group based beam reporting. For the differential L1-RSRP based reporting, e.g., for both simultaneous reception and transmission, the largest (measured, calculated, computed, averaged, etc.) value of L1-RSRP obtained, determined or identified for both simultaneous reception and transmission according to or following those specified herein in the present disclosure could be quantized to a 7-bit value in the range of [−140,−44] dBm with 1 dB step size, and a differential L1-RSRP value obtained, determined or identified for both simultaneous reception and transmission according to or following those specified herein in the present disclosure could be quantized to a 4-bit value with 2 dB step size with a reference to the largest (measured, calculated, computed, averaged, etc.) value of L1-RSRP obtained, determined or identified for both simultaneous reception and transmission according to or following those specified herein in the present disclosure which is part of the same L1-RSRP reporting instance.
   When/if differential beam reporting is enabled, e.g., only for simultaneous reception, e.g., when/if the higher layer parameter groupBasedBeamReporting-r18 is configured/provided and/or set to ‘JointULandDL’, and/or the number (e.g., configured/provided by the network via the corresponding higher layer parameter(s)) of the one or more groups of resource indicators is larger than one, and/or the number (e.g., configured/provided by the network via the corresponding higher layer parameter(s)) of one or more groups of beam metrics for simultaneous reception is larger than one, the UE could indicate, in a/the beam/CSI report or reporting instance, a second CSI resource set (e.g., in form of a second CSI resource set indicator) associate with the largest (measured, calculated, computed, averaged, etc.) value of beam metric (e.g., L1-RSRP) obtained, determined or identified for simultaneous reception according to or following those specified herein in the present disclosure. In this case, the second CSI resource set indicator could be a one-bit indicator with ‘0’ (or ‘1’) indicating a/the 1st CSI resource set and ‘1’ (or ‘0’) indicating a/the 2nd CSI resource set configured/provided/enabled for the group based beam reporting. For the differential L1-RSRP based reporting, e.g., only for simultaneous reception, the largest (measured, calculated, computed, averaged, etc.) value of L1-RSRP obtained, determined or identified for simultaneous reception according to or following those specified herein in the present disclosure could be quantized to a 7-bit value in the range of [−140,−44] dBm with 1 dB step size, and a differential L1-RSRP value obtained, determined or identified for simultaneous reception according to or following those specified herein in the present disclosure could be quantized to a 4-bit value with 2 dB step size with a reference to the largest (measured, calculated, computed, averaged, etc.) value of L1-RSRP obtained, determined or identified for simultaneous reception according to or following those specified herein in the present disclosure which is part of the same L1-RSRP reporting instance.
   When/if differential beam reporting is enabled, e.g., only for simultaneous transmission, e.g., when/if the higher layer parameter groupBasedBeamReporting-r18 is configured/provided and/or set to ‘JointULandDL’, and/or the number (e.g., configured/provided by the network via the corresponding higher layer parameter(s)) of the one or more groups of resource indicators is larger than one, and/or the number (e.g., configured/provided by the network via the corresponding higher layer parameter(s)) of one or more groups of beam metrics for simultaneous transmission is larger than one, the UE could indicate, in a/the beam/CSI report or reporting instance, a third CSI resource set (e.g., in form of a third CSI resource set indicator) associate with the largest (measured, calculated, computed, averaged, etc.) value of beam metric (e.g., L1-RSRP) obtained, determined or identified for simultaneous transmission according to or following those specified herein in the present disclosure. In this case, the third CSI resource set indicator could be a one-bit indicator with ‘0’ (or ‘1’) indicating a/the 1st CSI resource set and ‘1’ (or ‘0’) indicating a/the 2nd CSI resource set configured/provided/enabled for the group based beam reporting. For the differential L1-RSRP based reporting, e.g., only for simultaneous transmission, the largest (measured, calculated, computed, averaged, etc.) value of L1-RSRP obtained, determined or identified for simultaneous transmission according to or following those specified herein in the present disclosure could be quantized to a 7-bit value in the range of [−140,−44] dBm with 1 dB step size, and a differential L1-RSRP value obtained, determined or identified for simultaneous transmission according to or following those specified herein in the present disclosure could be quantized to a 4-bit value with 2 dB step size with a reference to the largest (measured, calculated, computed, averaged, etc.) value of L1-RSRP obtained, determined or identified for simultaneous transmission according to or following those specified herein in the present disclosure which is part of the same L1-RSRP reporting instance.
      For each group of resource indicators, CRI or SSBRI of the indicated k-th (kE {1, 2, 3}) CSI resource set is present first, wherein the value of k could be determined according to: (1) a fixed value (e.g., 1, 2 or 3) in system specification(s) or per RRC (re) configuration, (2) network's configuration(s)/indication(s), e.g., via higher layer RRC signaling(s)/parameter(s) and/or MAC CE command(s) and/or dynamic DCI based L1 signaling(s), according to or based on a corresponding UE's capability or capability signaling, and/or (3) UE's autonomous determination/selection, which could be further sent to the network via various UL channels/signals including CSI/beam report and/or UE's capability signaling(s).
In another example (example-V), the UE could report, in a/the beam/CSI report or reporting instance, a first group of beam metrics for both simultaneous reception and transmission and a second group of beam metrics for simultaneous reception corresponding/associated to a group of resource indicators for both simultaneous reception and transmission. For this design example, the UE could obtain, determine or identify the first group of beam metrics (including L1-RSRPs and/or L1-SINRs) for simultaneous reception and transmission based on or according to simultaneous reception and transmission of the RS resources including CSI-RS and/or SSB resources of the group of resource indicators for both simultaneous reception and transmission; in addition, the UE could obtain, determine or identify the second group of beam metrics (including L1-RSRPs and/or L1-SINRs) for simultaneous reception based on or according to only simultaneous reception of the RS resources including CSI-RS and/or SSB resources of the group of resource indicators for both simultaneous reception and transmission.
   When/if differential beam reporting is enabled, e.g., for both simultaneous reception and transmission, e.g., when/if the higher layer parameter groupBasedBeamReporting-r18 is configured/provided and/or set to ‘JointULandDL’, and/or the number (e.g., configured/provided by the network via the corresponding higher layer parameter(s)) of the one or more groups of resource indicators is larger than one, and/or the number (e.g., configured/provided by the network via the corresponding higher layer parameter(s)) of one or more groups of beam metrics for both simultaneous reception and transmission is larger than one, the UE could indicate, in a/the beam/CSI report or reporting instance, a first CSI resource set (e.g., in form of a first CSI resource set indicator) associate with the largest (measured, calculated, computed, averaged, etc.) value of beam metric (e.g., L1-RSRP) obtained, determined or identified for both simultaneous reception and transmission according to or following those specified herein in the present disclosure. In this case, the first CSI resource set indicator could be a one-bit indicator with ‘0’ (or ‘1’) indicating a/the 1st CSI resource set and ‘1’ (or ‘0’) indicating a/the 2nd CSI resource set configured/provided/enabled for the group based beam reporting. For the differential L1-RSRP based reporting, e.g., for both simultaneous reception and transmission, the largest (measured, calculated, computed, averaged, etc.) value of L1-RSRP obtained, determined or identified for both simultaneous reception and transmission according to or following those specified herein in the present disclosure could be quantized to a 7-bit value in the range of [−140,−44] dBm with 1 dB step size, and a differential L1-RSRP value obtained, determined or identified for both simultaneous reception and transmission according to or following those specified herein in the present disclosure could be quantized to a 4-bit value with 2 dB step size with a reference to the largest (measured, calculated, computed, averaged, etc.) value of L1-RSRP obtained, determined or identified for both simultaneous reception and transmission according to or following those specified herein in the present disclosure which is part of the same L1-RSRP reporting instance.
   When/if differential beam reporting is enabled, e.g., only for simultaneous reception, e.g., when/if the higher layer parameter groupBasedBeamReporting-r18 is configured/provided and/or set to ‘JointULandDL’, and/or the number (e.g., configured/provided by the network via the corresponding higher layer parameter(s)) of the one or more groups of resource indicators is larger than one, and/or the number (e.g., configured/provided by the network via the corresponding higher layer parameter(s)) of one or more groups of beam metrics for simultaneous reception is larger than one, the UE could indicate, in a/the beam/CSI report or reporting instance, a second CSI resource set (e.g., in form of a second CSI resource set indicator) associate with the largest (measured, calculated, computed, averaged, etc.) value of beam metric (e.g., L1-RSRP) obtained, determined or identified for simultaneous reception according to or following those specified herein in the present disclosure. In this case, the second CSI resource set indicator could be a one-bit indicator with ‘0’ (or ‘1’) indicating a/the 1st CSI resource set and ‘1’ (or ‘0’) indicating a/the 2nd CSI resource set configured/provided/enabled for the group based beam reporting. For the differential L1-RSRP based reporting, e.g., only for simultaneous reception, the largest (measured, calculated, computed, averaged, etc.) value of L1-RSRP obtained, determined or identified for simultaneous reception according to or following those specified herein in the present disclosure could be quantized to a 7-bit value in the range of [−140,−44] dBm with 1 dB step size, and a differential L1-RSRP value obtained, determined or identified for simultaneous reception according to or following those specified herein in the present disclosure could be quantized to a 4-bit value with 2 dB step size with a reference to the largest (measured, calculated, computed, averaged, etc.) value of L1-RSRP obtained, determined or identified for simultaneous reception according to or following those specified herein in the present disclosure which is part of the same L1-RSRP reporting instance.
      For each group of resource indicators, CRI or SSBRI of the indicated k-th (k∈{1, 2}) CSI resource set is present first, wherein the value of k could be determined according to: (1) a fixed value (e.g., 1 or 2) in system specification(s) or per RRC (re) configuration, (2) network's configuration(s)/indication(s), e.g., via higher layer RRC signaling(s)/parameter(s) and/or MAC CE command(s) and/or dynamic DCI based L1 signaling(s), according to or based on a corresponding UE's capability or capability signaling, and/or (3) UE's autonomous determination/selection, which could be further sent to the network via various UL channels/signals including CSI/beam report and/or UE's capability signaling(s).
In another example (example-VI), the UE could report, in a/the beam/CSI report or reporting instance, a first group of beam metrics for both simultaneous reception and transmission and a second group of beam metrics for simultaneous transmission corresponding/associated to a group of resource indicators for both simultaneous reception and transmission. For this design example, the UE could obtain, determine or identify the first group of beam metrics (including L1-RSRPs and/or L1-SINRs) for simultaneous reception and transmission based on or according to simultaneous reception and transmission of the RS resources including CSI-RS and/or SSB resources of the group of resource indicators for both simultaneous reception and transmission; in addition, the UE could obtain, determine or identify the second group of beam metrics (including L1-RSRPs and/or L1-SINRs) for simultaneous transmission based on or according to only simultaneous transmission of the RS resources including CSI-RS and/or SSB resources of the group of resource indicators for both simultaneous reception and transmission.
   When/if differential beam reporting is enabled, e.g., for both simultaneous reception and transmission, e.g., when/if the higher layer parameter groupBasedBeamReporting-r18 is configured/provided and/or set to ‘JointULandDL’, and/or the number (e.g., configured/provided by the network via the corresponding higher layer parameter(s)) of the one or more groups of resource indicators is larger than one, and/or the number (e.g., configured/provided by the network via the corresponding higher layer parameter(s)) of one or more groups of beam metrics for both simultaneous reception and transmission is larger than one, the UE could indicate, in a/the beam/CSI report or reporting instance, a first CSI resource set (e.g., in form of a first CSI resource set indicator) associate with the largest (measured, calculated, computed, averaged, etc.) value of beam metric (e.g., L1-RSRP) obtained, determined or identified for both simultaneous reception and transmission according to or following those specified herein in the present disclosure. In this case, the first CSI resource set indicator could be a one-bit indicator with ‘0’ (or ‘1’) indicating a/the 1st CSI resource set and ‘1’ (or ‘0’) indicating a/the 2nd CSI resource set configured/provided/enabled for the group based beam reporting. For the differential L1-RSRP based reporting, e.g., for both simultaneous reception and transmission, the largest (measured, calculated, computed, averaged, etc.) value of L1-RSRP obtained, determined or identified for both simultaneous reception and transmission according to or following those specified herein in the present disclosure could be quantized to a 7-bit value in the range of [−140,−44] dBm with 1 dB step size, and a differential L1-RSRP value obtained, determined or identified for both simultaneous reception and transmission according to or following those specified herein in the present disclosure could be quantized to a 4-bit value with 2 dB step size with a reference to the largest (measured, calculated, computed, averaged, etc.) value of L1-RSRP obtained, determined or identified for both simultaneous reception and transmission according to or following those specified herein in the present disclosure which is part of the same L1-RSRP reporting instance.
   When/if differential beam reporting is enabled, e.g., only for simultaneous transmission, e.g., when/if the higher layer parameter groupBasedBeamReporting-r18 is configured/provided and/or set to ‘JointULandDL’, and/or the number (e.g., configured/provided by the network via the corresponding higher layer parameter(s)) of the one or more groups of resource indicators is larger than one, and/or the number (e.g., configured/provided by the network via the corresponding higher layer parameter(s)) of one or more groups of beam metrics for simultaneous transmission is larger than one, the UE could indicate, in a/the beam/CSI report or reporting instance, a second CSI resource set (e.g., in form of a second CSI resource set indicator) associate with the largest (measured, calculated, computed, averaged, etc.) value of beam metric (e.g., L1-RSRP) obtained, determined or identified for simultaneous transmission according to or following those specified herein in the present disclosure. In this case, the second CSI resource set indicator could be a one-bit indicator with ‘0’ (or ‘1’) indicating a/the 1st CSI resource set and ‘1’ (or ‘0’) indicating a/the 2nd CSI resource set configured/provided/enabled for the group based beam reporting. For the differential L1-RSRP based reporting, e.g., only for simultaneous transmission, the largest (measured, calculated, computed, averaged, etc.) value of L1-RSRP obtained, determined or identified for simultaneous transmission according to or following those specified herein in the present disclosure could be quantized to a 7-bit value in the range of [−140,−44] dBm with 1 dB step size, and a differential L1-RSRP value obtained, determined or identified for simultaneous transmission according to or following those specified herein in the present disclosure could be quantized to a 4-bit value with 2 dB step size with a reference to the largest (measured, calculated, computed, averaged, etc.) value of L1-RSRP obtained, determined or identified for simultaneous transmission according to or following those specified herein in the present disclosure which is part of the same L1-RSRP reporting instance.
      For each group of resource indicators, CRI or SSBRI of the indicated k-th (k∈{1, 2}) CSI resource set is present first, wherein the value of k could be determined according to: (1) a fixed value (e.g., 1 or 2) in system specification(s) or per RRC (re) configuration, (2) network's configuration(s)/indication(s), e.g., via higher layer RRC signaling(s)/parameter(s) and/or MAC CE command(s) and/or dynamic DCI based L1 signaling(s), according to or based on a corresponding UE's capability or capability signaling, and/or (3) UE's autonomous determination/selection, which could be further sent to the network via various UL channels/signals including CSI/beam report and/or UE's capability signaling(s).
In another example (example-VII), the UE could report, in a/the beam/CSI report or reporting instance, a first group of beam metrics for simultaneous reception and a second group of beam metrics for simultaneous transmission corresponding/associated to a group of resource indicators for both simultaneous reception and transmission. For this design example, the UE could obtain, determine or identify the first group of beam metrics (including L1-RSRPs and/or L1-SINRs) for simultaneous reception based on or according to only simultaneous reception of the RS resources including CSI-RS and/or SSB resources of the group of resource indicators for both simultaneous reception and transmission; in addition, the UE could obtain, determine or identify the second group of beam metrics (including L1-RSRPs and/or L1-SINRs) for simultaneous transmission based on or according to only simultaneous transmission of the RS resources including CSI-RS and/or SSB resources of the group of resource indicators for both simultaneous reception and transmission.
   When/if differential beam reporting is enabled, e.g., only for simultaneous reception, e.g., when/if the higher layer parameter groupBasedBeamReporting-r18 is configured/provided and/or set to ‘JointULandDL’, and/or the number (e.g., configured/provided by the network via the corresponding higher layer parameter(s)) of the one or more groups of resource indicators is larger than one, and/or the number (e.g., configured/provided by the network via the corresponding higher layer parameter(s)) of one or more groups of beam metrics for simultaneous reception is larger than one, the UE could indicate, in a/the beam/CSI report or reporting instance, a first CSI resource set (e.g., in form of a first CSI resource set indicator) associate with the largest (measured, calculated, computed, averaged, etc.) value of beam metric (e.g., L1-RSRP) obtained, determined or identified for simultaneous reception according to or following those specified herein in the present disclosure. In this case, the first CSI resource set indicator could be a one-bit indicator with ‘0’ (or ‘1’) indicating a/the 1st CSI resource set and ‘1’ (or ‘0’) indicating a/the 2nd CSI resource set configured/provided/enabled for the group based beam reporting. For the differential L1-RSRP based reporting, e.g., only for simultanesous reception, the largest (measured, calculated, computed, averaged, etc.) value of L1-RSRP obtained, determined or identified for simultaneous reception according to or following those specified herein in the present disclosure could be quantized to a 7-bit value in the range of [−140,−44] dBm with 1 dB step size, and a differential L1-RSRP value obtained, determined or identified for simultaneous reception according to or following those specified herein in the present disclosure could be quantized to a 4-bit value with 2 dB step size with a reference to the largest (measured, calculated, computed, averaged, etc.) value of L1-RSRP obtained, determined or identified for simultaneous reception according to or following those specified herein in the present disclosure which is part of the same L1-RSRP reporting instance.
   When/if differential beam reporting is enabled, e.g., only for simultaneous transmission, e.g., when/if the higher layer parameter groupBasedBeamReporting-r18 is configured/provided and/or set to ‘JointULandDL’, and/or the number (e.g., configured/provided by the network via the corresponding higher layer parameter(s)) of the one or more groups of resource indicators is larger than one, and/or the number (e.g., configured/provided by the network via the corresponding higher layer parameter(s)) of one or more groups of beam metrics for simultaneous transmission is larger than one, the UE could indicate, in a/the beam/CSI report or reporting instance, a second CSI resource set (e.g., in form of a second CSI resource set indicator) associate with the largest (measured, calculated, computed, averaged, etc.) value of beam metric (e.g., L1-RSRP) obtained, determined or identified for simultaneous transmission according to or following those specified herein in the present disclosure. In this case, the second CSI resource set indicator could be a one-bit indicator with ‘0’ (or ‘1’) indicating a/the 1st CSI resource set and ‘1’ (or ‘0’) indicating a/the 2nd CSI resource set configured/provided/enabled for the group based beam reporting. For the differential L1-RSRP based reporting, e.g., for simultaneous transmission, the largest (measured, calculated, computed, averaged, etc.) value of L1-RSRP obtained, determined or identified for simultaneous transmission according to or following those specified herein in the present disclosure could be quantized to a 7-bit value in the range of [−140,−44] dBm with 1 dB step size, and a differential L1-RSRP value obtained, determined or identified for simultaneous transmission according to or following those specified herein in the present disclosure could be quantized to a 4-bit value with 2 dB step size with a reference to the largest (measured, calculated, computed, averaged, etc.) value of L1-RSRP obtained, determined or identified for simultaneous transmission according to or following those specified herein in the present disclosure which is part of the same L1-RSRP reporting instance.
      For each group of resource indicators, CRI or SSBRI of the indicated k-th (k∈{1, 2}) CSI resource set is present first, wherein the value of k could be determined according to: (1) a fixed value (e.g., 1 or 2) in system specification(s) or per RRC (re) configuration, (2) network's configuration(s)/indication(s), e.g., via higher layer RRC signaling(s)/parameter(s) and/or MAC CE command(s) and/or dynamic DCI based L1 signaling(s), according to or based on a corresponding UE's capability or capability signaling, and/or (3) UE's autonomous determination/selection, which could be further sent to the network via various UL channels/signals including CSI/beam report and/or UE's capability signaling(s).

The UE could report to the network one or more capabilities and/or capability signalings indicating their support of one or more of the report formats specified herein in the present disclosure, e.g., those specified/discussed/described in the design example-I, example-II, example-III, example-IV, example-V, example-VI, example-VII and example-VIII in the present disclosure. Furthermore, the UE could determine or identify which one or more of the report formats specified herein in the present disclosure, e.g., those specified/discussed/described in the design example-I, example-II, example-III, example-IV, example-V, example-VI, example-VII and example-VIII in the present disclosure to follow to conduct or perform the group based beam reporting according to or based on: (i) fixed rule(s)/value(s) in system specification(s) and/or per RRC (re) configuration, (ii) network's configuration(s) and/or indication(s), e.g., via higher layer RRC signaling(s)/parameter(s) and/or MAC CE command(s) and/or dynamic DCI based L1 signaling(s), based on or according to a corresponding UE's capability or capability signaling as specified/defined herein in the present disclosure, and/or (iii) UE's autonomous determination or selection, which coud be further sent to the network via various UL channels/signals in form/part of beam/CSI report(s), UE's capability signaling(s) and/or etc.

In the present disclosure, a UE (e.g., the 116) could determine/construct/form/formulate/indicate content(s) of a/the beam/CSI report and/or send to the network a/the beam/CSI report following one or more examples described herein, according to: (1) fixed rule(s) in system specifications, (2) network's configuration(s)/indication(s) via higher layer RRC signaling/parameter (e.g., via/through one or more indicators/bitmaps in CSI-ResourceConfig and/or CSI-ReportConfig) and/or MAC CE command and/or dynamic DCI based signaling, and/or (3) UE's autonomous determination/decision/selection (for this case, the UE could also send to the network, e.g., in part of a/the CSI/beam report, their determination/decision/selection of which one or more of the design examples as specified herein in the present disclosure is used/applied for determining/constructing/forming/formulating/indicating the content(s) of the beam/CSI report. For instance, when/if the difference between a first largest measured value of L1-RSRP among the first group(s) of resource indicators for simultaneous reception in a/the beam/CSI report and a second largest measured value of L1-RSRP among the second group(s) of resource indicators for simultaneous transmission in a/the beam/CSI report is less than or equal to a threshold, wherein the threshold could be: (i) a fixed or predefined threshold/value in system specifications, (ii) configured/provided/indicated by the network, e.g., via higher layer RRC signaling/parameter (e.g., in CSI-ResourceConfig and/or CSI-ReportConfig), and/or MAC CE command and/or dynamic DCI based L1 signaling, and/or (iii) autonomously determined by the UE and send to the network, e.g., in part of a/the reporting instance/CSI report, the UE could determine/construct/form/formulate/indicate content(s) of a/the beam/CSI report and/or send to the network a/the beam/CSI report following one or more examples described herein; otherwise, e.g., when/if the difference is greater than or equal to the threshold, the UE could determine/construct/form/formulate/indicate content(s) of a/the beam/CSI report and/or send to the network a/the beam/CSI report following one or more examples described herein.

The design examples of the differential group based beam reporting throughout the present disclosure provide differential RSRP reporting, which can be extended/applied to differential SINR reporting by modifying the corresponding quantization bit/resolution and/or quantization step size. Furthermore, the group based beam reporting format(s) specified herein in the present disclosure could comprise/contain/include two parts. Part 1 of the beam/CSI report could indicate/contain/include/comprise one or more groups of resource indicators for simultaneous reception as specified herein in the present disclosure and/or one or more groups of resource indicators for simultaneous transmission as specified herein in the present disclosure and/or the corresponding indicator(s) as specified herein in the present disclosure. The part 1 of the beam/CSI report could also indicate/contain/include/comprise a/the number of resource groups for simultaneous reception and/or a/the number of resource groups for simultaneous transmission that are reported in part 2 of the beam/CSI report. Furthermore, part 2 of the beam/CSI report could indicate/contain/include/comprise the remaining group(s) of resource indicators for simultaneous reception and/or transmission according to those specified herein in the present disclosure.

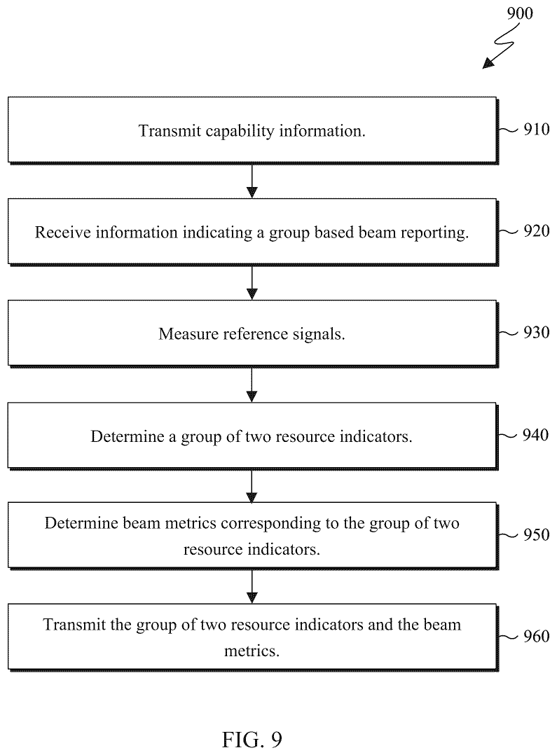

FIG. 9 illustrates an example method 900 performed by a UE in a wireless communication system according to embodiments of the present disclosure. The method 900 of FIG. 9 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 900 is for illustration only and other embodiments can be used without departing from the scope of the present disclosure.

The method 900 begins with the UE transmitting capability information 910. For example, in 910, the capability information indicates support of at least one of simultaneous reception via one or more spatial domain receive filters; simultaneous transmission via one or more spatial domain transmit filters; and simultaneous transmission and reception via one or more spatial domain transmit or receive filters, respectively.

The UE then receives information indicating a group based beam reporting 920. For example, in 920, the information is provided by a higher layer parameter groupBasedBeamReporting-r18. The UE then measures reference signals 930. The UE then determines a group of two resource indicators 940. For example, in 940, the determination is based on the information and the measurement and resource indicator in the group of two resource indicators is one of a SSBRI and a CRI.

The UE then determines beam metrics corresponding to the group of two resource indicators 950. For example, in 950, the determination is based on the measurement and beam metric in the beam metrics is one of a L1-RSRP and a L1-SINR. The UE then transmit, in a CSI reporting instance, the group of two resource indicators and the beam metrics 960.

In various embodiments, when the higher layer parameter groupBasedBeamReporting-r18 is set to ‘DLonly’, a first portion of the reference signals that correspond to the group of two resource indicators are simultaneous received via one or more spatial domain receive filters; and when the higher layer parameter groupBasedBeamReporting-r18 is set to ‘ULonly’, a second portion of the reference signals that correspond to the group of two resource indicators are simultaneous transmitted via one or more spatial domain transmit filters.

In various embodiments, when the higher layer parameter groupBasedBeamReporting-r18 is set to ‘bothDLand (IL’, a first portion of the reference signals that correspond to the group of two resource indicators are simultaneous received via one or more spatial domain receive filters and simultaneously transmitted via one or more spatial domain transmit filters.

In various embodiments, when a differential beam reporting is enabled, the UE transmits, in the CSI reporting instance, one or more groups of differential beam metrics with a reference to a beam metric for both simultaneous reception and simultaneous transmission.

In various embodiments, the UE transmit, in the CSI reporting instance, a first group of two beam metrics associated with the group of two resource indicators for simultaneous reception; a second group of two beam metrics associated with the group of two resource indicators for simultaneous transmission; and when differential beam reporting is enabled: one or more first groups of differential beam metrics with a reference to a beam metric for simultaneous reception, and one or more second groups of differential beam metrics with a reference to a beam metric for simultaneous transmission.

Any of the above variation embodiments can be utilized independently or in combination with at least one other variation embodiment.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
transmit capability information; and
receive information indicating a group based beam reporting; and
a processor operably coupled with the transceiver, the processor configured to:
measure reference signals,
determine, based on the information and the measurement, a group of two resource indicators, and
determine, based on the measurement, beam metrics corresponding to the group of two resource indicators; and
wherein the transceiver is further configured to transmit, in a channel state information (CSI) reporting instance, the group of two resource indicators and the beam metrics,
wherein a resource indicator in the group of two resource indicators is one of: (1) a synchronization signal/physical broadcast channel (PBCH) block (SSB) resource indicator (SSBRI) and (2) a CSI reference signal (CSI-RS) resource indicator (CRI), and
wherein a beam metric in the beam metrics is one of: (1) a layer-1 reference signal received power (L1-RSRP) and (2) a layer-1 signal to interference and noise ratio (L1-SINR).

2. The UE of claim 1, wherein the capability information indicates support of at least one of:
simultaneous reception via one or more spatial domain receive filters;
simultaneous transmission via one or more spatial domain transmit filters; and
simultaneous transmission and reception via one or more spatial domain transmit or receive filters, respectively.

3. The UE of claim 1, wherein the information is provided by a higher layer parameter groupBasedBeamReporting-r18.

4. The UE of claim 3, wherein:
when the higher layer parameter groupBasedBeamReporting-r18 is set to ‘DLonly’, a first portion of the reference signals that correspond to the group of two resource indicators are simultaneous received via one or more spatial domain receive filters; and
when the higher layer parameter groupBasedBeamReporting-r18 is set to ‘ULonly’, a second portion of the reference signals that correspond to the group of two resource indicators are simultaneous transmitted via one or more spatial domain transmit filters.

5. The UE of claim 3, wherein, when the higher layer parameter groupBasedBeamReporting-r18 is set to ‘bothDLandUL’, a portion of the reference signals that correspond to the group of two resource indicators are simultaneous received via one or more spatial domain receive filters and simultaneously transmitted via one or more spatial domain transmit filters.

6. The UE of claim 5, wherein, when a differential beam reporting is enabled, the transceiver is further configured to transmit, in the CSI reporting instance, one or more groups of differential beam metrics with a reference to a beam metric for both simultaneous reception and simultaneous transmission.

7. The UE of claim 5, wherein:
the transceiver is further configured to transmit, in the CSI reporting instance:
a first group of two beam metrics associated with the group of two resource indicators for simultaneous reception;
a second group of two beam metrics associated with the group of two resource indicators for simultaneous transmission; and
when differential beam reporting is enabled:
one or more first groups of differential beam metrics with a reference to a beam metric for simultaneous reception; and
one or more second groups of differential beam metrics with a reference to a beam metric for simultaneous transmission.

8. A base station (BS), comprising:
a processor; and
a transceiver operably coupled with the processor, the transceiver configured to:
receive capability information;
transmit information indicating a group based beam reporting; and
receive, in a channel state information (CSI) reporting instance, a group of two resource indicators and beam metrics corresponding to the group of two resource indicators,
wherein a resource indicator in the group of two resource indicators is one of: (1) a synchronization signal/physical broadcast channel (PBCH) block (SSB) resource indicator (SSBRI) and (2) a CSI reference signal (CSI-RS) resource indicator (CRI), and
wherein a beam metric in the beam metrics is one of: (1) a layer-1 reference signal received power (L1-RSRP) and (2) a layer-1 signal to interference and noise ratio (L1-SINR).

9. The BS of claim 8, wherein the capability information indicates support of at least one of:
simultaneous reception via one or more spatial domain receive filters;
simultaneous transmission via one or more spatial domain transmit filters; and
simultaneous transmission and reception via one or more spatial domain transmit or receive filters, respectively.

10. The BS of claim 8, wherein the information is provided by a higher layer parameter groupBasedBeamReporting-r18.

11. The BS of claim 10, wherein:
when the higher layer parameter groupBasedBeamReporting-r18 is set to ‘DLonly’, a first portion of reference signals that correspond to the group of two resource indicators are simultaneous transmitted via one or more spatial domain transmit filters; and
when the higher layer parameter groupBasedBeamReporting-r18 is set to ‘ULonly’, a second portion of reference signals that correspond to the group of two resource indicators are simultaneous received via one or more spatial domain receive filters.

12. The BS of claim 10, wherein, when the higher layer parameter groupBasedBeamReporting-r18 is set to ‘bothDLandUL’, a portion of reference signals that correspond to the group of two resource indicators are simultaneous received via one or more spatial domain receive filters and simultaneously transmitted via one or more spatial domain transmit filters.

13. The BS of claim 12, wherein, when a differential beam reporting is enabled, the transceiver is further configured to receive, in the CSI reporting instance, one or more groups of differential beam metrics with a reference to a beam metric for both simultaneous reception and simultaneous transmission.

14. The BS of claim 12, wherein:
the transceiver is further configured to receive, in the CSI reporting instance:
a first group of two beam metrics associated with the group of two resource indicators for simultaneous reception;
a second group of two beam metrics associated with the group of two resource indicators for simultaneous transmission; and
when differential beam reporting is enabled:
one or more first groups of differential beam metrics with a reference to a beam metric for simultaneous reception; and
one or more second groups of differential beam metrics with a reference to a beam metric for simultaneous transmission.

15. A method performed by a user equipment (UE), the method comprising:
transmitting capability information;
receiving information indicating a group based beam reporting;
measuring reference signals;
determining, based on the information and the measurement, a group of two resource indicators;
determining, based on the measurement, beam metrics corresponding to the group of two resource indicators; and
transmitting, in a channel state information (CSI) reporting instance, the group of two resource indicators and the beam metrics,
wherein a resource indicator in the group of two resource indicators is one of: (1) a synchronization signal/physical broadcast channel (PBCH) block (SSB) resource indicator (SSBRI) and (2) a CSI reference signal (CSI-RS) resource indicator (CRI), and
wherein a beam metric in the beam metrics is one of: (1) a layer-1 reference signal received power (L1-RSRP) and (2) a layer-1 signal to interference and noise ratio (L1-SINR).

16. The method of claim 15, wherein the capability information indicates support of at least one of:
simultaneous reception via one or more spatial domain receive filters;
simultaneous transmission via one or more spatial domain transmit filters; and
simultaneous transmission and reception via one or more spatial domain transmit or receive filters, respectively.

17. The method of claim 15, wherein the information is provided by a higher layer parameter groupBasedBeamReporting-r18.

18. The method of claim 17, wherein:
when the higher layer parameter groupBasedBeamReporting-r18 is set to ‘DLonly’, a first portion of the reference signals that correspond to the group of two resource indicators are simultaneous received via one or more spatial domain receive filters; and
when the higher layer parameter groupBasedBeamReporting-r18 is set to ‘ULonly’, a second portion of the reference signals that correspond to the group of two resource indicators are simultaneous transmitted via one or more spatial domain transmit filters.

19. The method of claim 17, wherein when the higher layer parameter groupBasedBeamReporting-r18 is set to ‘bothDLandUL’, a portion of the reference signals that correspond to the group of two resource indicators are simultaneous received via one or more spatial domain receive filters and simultaneously transmitted via one or more spatial domain transmit filters.

20. The method of claim 19, wherein transmitting, in the CSI reporting instance, the group of two resource indicators and the beam metrics further comprises, when a differential beam reporting is enabled, transmitting, in the CSI reporting instance, one or more groups of differential beam metrics with a reference to a beam metric for both simultaneous reception and simultaneous transmission.
